(19) United States
(12) Patent Application Publication
(10) Pub. No.: US 2016/0249364 A1
(43) Pub. Date: Aug. 25, 2016

(54) A RADIO NODE, A CONTROLLING NODE, A COORDINATING NODE AND METHODS THEREIN

(71) Applicant: Telefonaktiebolaget L M Ericsson (publ), Stockholm (SE)

(72) Inventor: Iana Siomina, Solna (SE)

(21) Appl. No.: 14/234,535

(22) PCT Filed: Dec. 6, 2013
(86) PCT No.: PCT/SE2013/051466

§ 371 Date: Jan. 23, 2014

Related U.S. Application Data
(60) Provisional application No. 61/749,944, filed on Jan. 8, 2013.

(51) Int. Cl. H04W 72/08; H04W 16/32; H04W 48/08; H04B 7/08; H04W 72/04

(52) U.S. Cl. CPC H04W 72/082; H04B 7/08; H04W 72/0413; H04W 48/08; H04W 16/32; H04W 84/042

(57) ABSTRACT

Method in a radio node (RN) comprising an enhanced receiver, of handling interference. The RN operates in a radio communications network (RCN). The RN obtains a bandwidth information for a determined interferer in the RCN. The interferer is a first signal, first channel, first radio node, first antenna or first cell, interfering on a second signal, second channel, second radio node, second antenna or second cell in the RCN. The RN applies the enhanced receiver to mitigate interference from the interferer using the obtained information. The RN applies the enhanced receiver to perform at least one radio measurement on the second signal, second channel, second radio node, second antenna or second cell. Also described is a network node (NN) that receives from the RN a capability information associated with an ability of the RN to mitigate interference. The NN performs a configuration, coordination, scheduling or decision, using the received information.

### TECHNICAL FIELD

Embodiments herein relate to wireless, i.e., radio, communication networks and in particular to the networks where enhanced receivers in radio nodes are used to handle interference.

### BACKGROUND

In today's radio communications networks a number of different technologies are used, such as Long Term Evolution (LTE), LTE-Advanced, 3rd Generation Partnership Project (3GPP) Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible technologies. A radio communications network comprises radio base stations providing radio coverage over at least one respective geographical area forming a cell. User Equipments (UE) are served in the cells by the respective radio base station and are communicating with respective radio base station. The user equipments transmit data over a radio interface to the radio base stations in UpLink (UL) transmissions and the radio base stations transmit data to the user equipments in DownLink (DL) transmissions.

### 1.1 Enhanced Receivers for Interference Handling

In Universal Mobile Telecommunications System (UMTS)/High Speed Downlink Packet Access (HSDPA) several interference aware receivers have been specified for a UE. They are termed as ‘enhanced receivers’ as opposed to the baseline receiver, i.e., rake receiver. The UMTS enhanced receivers are referred to as enhanced receiver type 1, with two-branch receiver diversity, enhanced receiver type 2, with single-branch equalizer, enhanced receiver type 3, with two branch receiver diversity and equalizer and enhanced receiver type 3i, with two branch receiver diversity and inter-cell interference cancellation capability. The new receivers may be used to improve performance, e.g., in terms of throughput and/or coverage.

In LTE Rel-10, enhanced interference coordination techniques have been developed to mitigate potentially high interference, e.g., in a cell range expansion zone, while providing the UE with time-domain measurement restriction information. Further, for LTE Rel-11, advanced receivers based on Minimum Mean Square Error-Interference Rejection Combining (MMSE-IRC) with several covariance estimation techniques and interference-cancellation-capable receivers, for different types of signals and channels, have been studied. In future even more complex advanced receivers, e.g., Minimum Mean Square Error-Successive Interference Cancellation (MMSE-SIC), which is capable of performing nonlinear subtractive-type interference cancellation, can be used to further enhance system performance.

Such techniques generally may benefit all deployments where relatively high interference of one or more signals is experienced when performing measurements on radio signals or channels transmitted by radio nodes or devices, but are particularly useful in heterogeneous deployments. However, these techniques involve also additional complexity, e.g., may require more processing power and/or more memory. Due to these factors such receiver may be used by the UE for mitigating interference on specific signals or channels. For example a UE may apply an interference mitigation or cancellation technique only on data channel. In another example a more sophisticated UE may apply interference mitigation on data channel as well as on one or two common control signals; examples of common control signals are reference signal, synchronization signals etc.

It should be noted that the terms interference mitigation receiver, interference cancellation receiver, interference suppression receiver, interference rejection receiver, interference aware receiver, interference avoidance receiver etc. are interchangeably used but they all belong to a category of an advanced receiver or an enhanced receiver. All these different types of enhanced receiver improve performance by fully or partly eliminating the interference arising from at least one interfering source. The interfering source is generally the strongest interferer/s, which are signals from the neighbouring cells when the action is performed in the UE. Therefore a more generic term, ‘enhanced receiver’, which covers all variants of advanced receiver, is used hereinafter. Further, the corresponding interference handling techniques, e.g., interference cancellation, interference suppression, puncturing or interference rejection combining, for enhanced receivers are termed ‘enhanced receiver technique’ herein.

### 1.2 Heterogeneous Deployments

The interest in deploying low-power nodes, such as pico base stations, Home evolved NodeBs (HeNodeB), relays, remote radio heads, etc., for enhancing the macro network performance in terms of the network coverage, capacity and service experience of individual users has been constantly increasing over the last few years. At the same time, there has been realized a need for enhanced interference management techniques to address the arising interference issues caused, for example, by a significant transmit power variation among different cells and cell association techniques developed earlier for more uniform networks.

In 3GPP, heterogeneous network deployments have been defined as deployments where low-power nodes of different transmit powers are placed throughout a macro-cell layout, implying also non-uniform traffic distribution. Such deployments are, for example, effective for capacity extension in certain areas, so-called traffic hotspots, i.e. small geographical areas with a higher user density and/or higher traffic intensity where installation of pico nodes can be considered to enhance performance. Heterogeneous deployments may also be viewed as a way of densifying networks to adopt for the traffic needs and the environment. However, heterogeneous deployments bring also challenges for which the network has to be prepared to ensure efficient network operation and superior user experience. Some challenges are related to the increased interference in the attempt to increase small cells associated with low-power nodes, aka cell range expansion; the other challenges are related to potentially high interference in uplink due to a mix of large and small cells.

According to 3GPP, heterogeneous deployments consist of deployments where low power nodes are placed throughout a macro-cell layout. The interference characteristics in a heterogeneous deployment can be significantly different than in a homogeneous deployment, in downlink or uplink or both. Examples hereof are given in FIG. 1, where in case (a), a macro user with no access to the Closed Subscriber Group (CSG) cell will be interfered by the HeNodeB, in case (b) a macro user causes severe interference towards the HeNodeB, in case (c) a CSG user is interfered by another CSG HeNodeB, and in case (d) a UE is served by a pico cell in the expended cell range area. In general, one should note that a heterogeneous deployment does not necessarily involve CSG cells.

### 1.2.1 Cell Range Expansion

Another challenging interference scenario occurs with so-called cell range expansion, when the traditional downlink cell assignment rule diverges from the Reference Signal Received Power (RSRP)-based approach, e.g. towards pathloss- or pathgain-based approach, e.g., when adopted for cells with a transmit power lower than neighbor cells. The idea of the cell range expansion is illustrated in FIG. 2, where the cell range expansion of a pico cell of a pico BS is implemented by means of a delta-parameter, Δ. In the figure, the UE is connected to the pico BS, and is in the area, i.e. cell range expansion area, where the received signal power, e.g., the RSRP, from the macro BS, denoted by RSRP_{macro} and an short-dashed line, is stronger than the received signal power, e.g., RSRP, from the pico BS, denoted by RSRP_{pico} and an long-dashed line. The maximum difference between the two signal strengths, i.e., the maximum size of the area, is determined by the offset ‘delta’, i.e., Δ, and illustrated in the figure as the expanded cell range: RSRP_{pico+}Δ and a continuous line bounding the area. Conventional cell range is determined by the boundary where RSRP_{pico} and RSRP_{macro} are equal, and thus the short-dashed line and the long-dashed line cross.

The UE may potentially see a larger pico cell coverage area, i.e., expanded cell range: RSRP_{pico+}Δ, when the delta-parameter is used in cell selection/reselection, that is, when the short-dashed line crosses the continuous line, than when it is not. The cell range expansion is limited by the DL performance since UL performance typically improves when the cell sizes of neighbor cells become more balanced.

### 1.2.2 DL Interference Handling in Heterogeneous Deployments

To ensure reliable and high-bitrate transmissions as well as robust control channel performance, maintaining a good signal quality is a must in wireless networks. The signal quality is determined by the received signal strength and its relation to the total interference and noise received by the receiver. A good network plan, which, among the others also includes cell planning, is a prerequisite for the successful network operation, but it is static. For more efficient radio resource utilization, it has to be complemented at least by semi-static and dynamic radio resource management mechanisms, which are also intended to facilitate interference management, and deploying more advanced antenna technologies and algorithms.

One way to handle interference is, for example, to adopt more advanced transceiver technologies, e.g. by implementing interference cancellation mechanisms in terminals. Another way, which can be complementary to the former, is to design efficient interference coordination algorithms and transmission schemes in the network. The coordination may be realized in static, semi-static or dynamic fashion. Static or semi-static schemes may rely on reserving time-frequency resources, e.g., a part of the bandwidth and/or time instances that are orthogonal for strongly interfering transmissions. Dynamic coordination may be implemented e.g. by means of scheduling. Such interference coordination may be implemented for all or specific channels, e.g., data channels or control channels, or signals.

Specifically for heterogeneous deployments, there have been standardized enhanced Inter-Cell Interference Coordination (eICIC) mechanisms for ensuring that the UE performs at least some measurements, e.g., Radio Resource Management (RRM), Radio Link Monitoring (RLM) and Channel State Information (CSI) measurements, in low-interference subframes of the interfering cell. These mechanisms involve configuring patterns of low-interference subframes at transmitting nodes, and hereby reducing interference, and configuring measurement patterns for UEs, and hereby indicating to the UEs low-interference measurement occasion.

Two types of patterns have been defined for eICIC in LTE Rel-10 to enable restricted measurements in DL:
Restricted measurement patterns, which are configured by a network node and signaled to the UE,
Transmission patterns, a.k.a. Almost Blank Subframe (ABS) patterns, which are configured by a network node, describe the transmission activity of a radio node, and may be exchanged between the radio nodes.

### 1.2.2.1 DL Restricted Measurement Patterns

To enable restricted measurements for RRM, e.g., RSRP/Reference Signal Received Quality (RSRQ), RLM, CSI as well as for demodulation, the UE may receive via Radio Resource Control (RRC) UE-specific signaling the following set of patterns [TS 36.331 v10.1.0],
Pattern 1: A single RRM/RLM measurement resource restriction for the serving cell.
Pattern 2: One RRM measurement resource restriction for neighbour cells, up to 32 cells per frequency, currently only for the serving frequency.
Pattern 3: Resource restriction for CSI measurement of the serving cell with 2 subframe subsets configured per UE.

A pattern is a bit string indicating restricted and unrestricted subframes characterized by a length and periodicity, which are different for Frequency-Division Duplexing (FDD) and Time-Division Duplexing (TDD), 40 subframes for FDD and 20, 60 or 70 subframes for TDD.

Restricted measurement subframes are configured to allow the UE to perform measurements in subframes with improved interference conditions, which may be implemented by configuring Almost Blank Subframe (ABS) patterns at eNodeBs.

In addition to RRM/RLM, Pattern 1 may also be used to enable UE Reception-Transmission (Rx-Tx) measurements in low-interference conditions or in principle for any Cell-specific Reference Signals (CRS)-based measurement to improve the measurement performance when the strong interference may be reduced by configuring low-interference subframes. Pattern 3 would typically be used for enhancing channel quality reporting, and improving the performance of channel demodulation and decoding, e.g., of data channels such as Physical Downlink Shared CHannel (PDSCH), control channels such as Physical Downlink Control CHannel (PDCCH), Physical Control Format Indicator Channel (PCFICH), Physical Hybrid ARQ Indicator CHannel (PHICH). Pattern 1 and Pattern 2 may also be used for enabling low-interference conditions for common signals, e.g., Primary Synchronization Signal (PSS)/Secondary Synchronization Signal (SSS), common channels, and broadcast/multicast channels, e.g., Physical Broadcast CHannel (PBCH), when the strong interference can be reduced or avoided, e.g., when a time shift is applied to ensure that the common channels/signals are interfered by data whose interference may be avoided by configuring low-interference subframes and hereby suppressing the interfering data transmissions.

### 1.2.2.2 DL ABS Patterns

An ABS pattern indicates subframes when the eNodeB restricts its transmissions, e.g., does not schedule or transmits at a lower power. The subframes with restricted transmissions are referred to as ABS subframes. In the current standard, eNodeBs can suppress data transmissions in ABS subframes but the ABS subframes cannot be fully blank—at least some of the control channels and physical signals are still transmitted. Examples of control channels that are transmitted in ABS subframes even when no data is transmitted are PBCH and PHICH. Examples of physical signals that have to be transmitted, disregard on whether the subframes are ABS or not, are Cell-specific Reference Signals (CRS) and Synchronization Signals (PSS and SSS). Positioning Reference Signals (PRS) may also be transmitted in ABS subframes.

If a Multimedia Broadcast Single Frequency Network (MBSFN) subframe coincides with an ABS, the subframe is also considered as ABS [TS 36.423 v. 11.3.0]. CRS are not transmitted in MBSFN subframes, except for the first symbol, which allows for avoiding CRS interference from an aggressor cell to the data region of a measured cell,

ABS patterns may be exchanged between eNodeBs, e.g., via X2, but these patterns are not signaled to the UE.

### 1.2.2.3 Aggressor Cell Information

In Rel-11, for enhanced receivers, e.g., capable of interference cancellation, the information about strongly interfering cell, a.k.a. aggressor cell, may be provided to facilitate handling the strong interference generated by transmissions in that cell. The currently agreed information is as below, i.e., the following information about the interfering cells may be provided to the UE: Physical Cell Identity (PCI), number of CRS antenna ports, and MBSFN subframe configuration.

| | |
|---|---|
| NeighCellsCRS-Info-r11 ::= | CHOICE { |
| release | NULL, |
| setup | CRS-AssistanceInfoList-r11 |
| } | |
| CRS-AssistanceInfoList-r11 ::= | SEQUENCE (SIZE (1.. maxCellReport)) OF CRS- |
| AssistanceInfo | |

| | |
|---|---|
| CRS-AssistanceInfo ::= SEQUENCE { | |
| physCellId-r11 | PhysCellId, |
| antennaPortsCount-r11 | ENUMERATED {an1, an2, an4, spare1}, |
| mbsfn-SubframeConfigList-r11 | MBSFN-SubframeConfigList |

### 1.2.2.4 System Information Acquisition

In LTE, the system information is divided into the MasterInformationBlock (MIB) and a number of SystemInformationBlocks (SIBs), e.g.:
MasterInformationBlock defines the most essential physical layer information of the cell required to receive further system information; parameters:
dl-Bandwidth
phich-Config
systemFrameNumber
SystemInformationBlockType1 contains information relevant when evaluating if a UE is allowed to access a cell and defines the scheduling of other system information blocks; selected parameters:
plmn-IdentityList
trackingAreaCode
cellIdentity within Public Land Mobile Network (PLMN)
CSG indication, CSG Identifier (ID)
cellSelectionInfo, intraFregReselection, yes/no, q-RxLevMin, q-RxLevMinOffset, q-QualMin, q-QualMinOffset
p-Max, i.e., maximum UE power allowed per cell
freqBandIndicator
schedulingInfoList, si-WindowLength, si-Periodicity, sib-Mapping
tdd-Config

### 1.2.2.4.1 MIB and PBCH

The MIB is mapped on the Broadcast Control CHannel (BCCH) and carried on Broadcast CHannel (BCH) while all other System Information (SI) messages are mapped on the BCCH and dynamically carried on DL-Synchronization CHannel (SCH) where they can be identified through the System Information RNTI (SI-RNTI). MIB is transmitted according to a fixed schedule with a periodicity of 40 milliseconds (ms) in subframes #0. To improve MIB detection performance, 3 redundancy versions are also signalled with 10 ms period.

To enhance UE performance under high interference conditions, the UE may perform interference cancellation of aggressor PBCH. PBCH of a cell is aggressor to another-cell PBCH when they overlap in time on the same frequency, e.g., when the cells have radio frame boundaries aligned, though not necessarily having the same MIB redundancy versions, as illustrated in FIG. 3. FIG. 3 represents two time lines for two different cells, i.e., cell 1 and cell 2. MIB is transmitted in subframes 4 times periodically, represented as three retransmissions B2, B3, B4 after the first original transmission B1. The subframe number and radio frame numbers are indicated.

The figure also illustrates a scenario where radio frame boundaries are time-aligned, that is, 1 radio frame has 10 subframes, and B1 is time-aligned with B3.

MIB interference cancellation may or may not involve MIB decoding.

### 1.2.2.4.2 SIBs

SIB1 is transmitted according to a fixed schedule with a periodicity of 80 ms in subframes #5. To improve SIB1 detection performance, 3 redundancy versions are also signalled with 20 ms period.

The scheduling of other SI messages, e.g., periodicity and SI-window is flexible and indicated by SystemInformationBlockType1. Each SIB is contained only in a single SI message, only SIBs having the same scheduling requirement, i.e., periodicity, can be mapped to the same SI message. There is also a limit on the maximum size of a SI message, e.g., 217 bytes with DCI format 1C and 277 bytes with 1a format.

The obtained SI is stored by the UE and considered invalid after 3 hours.

The Paging message is used to inform UEs in RRC_IDLE and UEs in RRC_CONNECTED about a system information change.

System information may also be provided to the UE by means of dedicated signalling e.g. upon handover. Furthermore, to facilitate receiver performance in high-interference conditions, according to 3GPP TS 36.300, v11.4.0, 2013-01-03, the network may provide SIB1 to the UE in the Cell Range Extension (CRE) region by a dedicated RRC signaling to assist UE system information acquisition. According to TS 36.331 v. 11.1.0, in addition to system information broadcast the Evolved Universal Terrestrial Radio Access Network (E-UTRAN) may provide the same SystemInformationBlockType1 via dedicated signalling in the RRCConnectionReconfiguration message.

### [TS 36.331 v. 11.1.0]

RRCConnectionReconfiguration-v1020-IEs ::= SEQUENCE {

| | | | |
|---|---|---|---|
| sCellToReleaseList-r10 | SCellToReleaseList-r10 | OPTIONAL, | -- Need |
| ON | | | |
| sCellToAddModList-r10 | SCellToAddModList-r10 | OPTIONAL, | -- Need |
| ON | | | |

| | |
|---|---|
| nonCriticalExtension | RRCConnectionReconfiguration-v11xx-IEs |
| OPTIONAL | |
| } | |

RRCConnectionReconfiguration-v11xx-IEs ::= SEQUENCE {

| | |
|---|---|
| systemInfomationBlockType1Dedicated-r11 | OCTET STRING (CONTAINING |

| | SystemInformationBlockType1) | OPTIONAL, | -- Need |
|---|---|---|---|
| | ON | | |
| nonCriticalExtension | SEQUENCE { } | OPTIONAL | -- Need |
| OP | | | |
| } | | | |

### 1.3 Interference Handling in Non-Heterogeneous Deployments

Enhanced receivers may be used also in homogeneous network deployments where high inter-cell interference conditions may also occur, depending on the UE location and Base Station (BS) locations. One example of homogeneous deployments is a macro cell network deployment. Another non-limiting example is a dense network of small cells, e.g., micro or pico cells, without macro cells. There may also be “islands”, i.e., areas, with homogeneous deployments in a heterogeneous network deployment, and vice versa.

### 1.4 Radio Signal Measurements

### 1.4.1 RRM Measurements

Radio Resource Management (RRM) measurements are performed to support RRM the purpose of which is to ensure the efficient use the available radio resources and to provide mechanisms that enable a radio network to meet radio resource related requirements. In particular, RRM in E-UTRAN provides means to manage, e.g., assign, re-assign and release, radio resources taking into account single and multi-cell aspects. Some example RRM functions are radio bearer control, power control, radio admission control, connection mobility control, dynamic resource allocation and packet scheduling, Inter-Cell Interference Coordination (ICIC), some Self-Optimized Networks (SON) functions related to radio resources, and load balancing. RRM may be intra-Radio Access Technology (RAT) and inter-RAT, and the measurements may be intra-frequency, inter-frequency and inter-RAT.

The RRM measurements are performed by either UE or radio nodes, collected and used by the network in a centralized or distributed manner.

The example RRM measurements are:
Radio Link Monitoring (RLM) which is based on out of sync and in sync detection of a serving cell,
   The downlink radio link quality of the Primary Cell (PCell) shall be monitored by the UE for the purpose of indicating out-of-sync/in-sync status to higher layers. In non-Discontinuous Reception (DRX) mode operation, the physical layer in the UE shall every radio frame assess the radio link quality, evaluated over the pre-defined previous time period, against thresholds, such as (Qout) and (Qin) defined by relevant tests. In DRX mode operation, the physical layer in the UE shall at least once every DRX period assess the radio link quality, evaluated over the pre-defined previous time period, against thresholds (Qout and Qin) defined by relevant tests.
Cell identification reporting e.g. E-UTRA cell search, inter-RAT UTRAN cell search, SI acquisition, etc.,
UE transmit power or UE power headroom, e.g., difference between max output power and transmitted power on log scale,
Radio node transmit power, e.g., total or for specific channels or signals,
Any signal strength and signal quality in general,
Interference and pathloss measurements,
Timing measurements, e.g., Round-Trip Time (RTT), UE Rx-Tx, eNodeB Rx-Tx, Timing Advance, propagation delay, etc. . . .

### 1.5 Multi-Carrier or Carrier Aggregation Concept

To enhance peak rates within a technology, multi-carrier or carrier aggregation solutions are known. Each carrier in multi-carrier or carrier aggregation system is generally termed as a Component Carrier (CC) or sometimes it is also referred to as a cell. In simple words the CC means an individual carrier in a multi-carrier system. The term Carrier Aggregation (CA) is also called, e.g., interchangeably called, “multi-carrier system”, “multi-cell operation”, “multi-carrier operation”, “multi-carrier” transmission and/or reception. This means the CA is used for transmission of signaling and data in the uplink and downlink directions. One of the CCs is the Primary Component Carrier (PCC) or simply primary carrier or even anchor carrier. The remaining ones are called Secondary Component Carrier (SCC) or simply secondary carriers or even supplementary carriers. Generally the primary or anchor CC carries the essential UE specific signaling. The primary CC exists in both uplink and direction CA. The network may assign different primary carriers to different UEs operating in the same sector or cell.

Therefore the UE has more than one serving cell in downlink and/or in the uplink: one primary serving cell and one or more secondary serving cells operating on the PCC and SCC respectively. The serving cell is interchangeably called as Primary Cell (PCell) or Primary Serving Cell (PSC). Similarly the secondary serving cell is interchangeably called as Secondary Cell (SCell) or Secondary Serving Cell (SSC). Regardless of the terminology, the PCell and SCell/s enable the UE to receive and/or transmit data. More specifically the PCell and SCell exist in DL and UL for the reception and transmission of data by the UE. The remaining non-serving cells on the PCC and SCC are called neighbor cells.

The CCs belonging to the CA may belong to the same frequency band, aka intra-band CA, or to different frequency band, e.g., inter-band CA, or any combination thereof, e.g., 2 CCs in band A and 1 CC in band B. Furthermore, the CCs in intra-band CA may be adjacent or non-adjacent in frequency domain, aka intra-band non-adjacent CA. A hybrid CA comprising of any two of intra-band adjacent, intra-band non-adjacent and inter-band is also possible. Using carrier aggregation between carriers of different technologies is also referred to as “multi-RAT carrier aggregation” or “multi-RAT-multi-carrier system” or simply “inter-RAT carrier aggregation”. For example, the carriers from WCDMA and LTE may be aggregated. Another example is the aggregation of LTE FDD and LTE TDD, which may also be interchangeably called as multi-duplex carrier aggregation system. Yet another example is the aggregation of LTE and Code Division Multiple Access (CDMA) 2000 carriers. For the sake of clarity the carrier aggregation within the same technology as described can be regarded as Intra-RAT′ or simply ‘single RAT’ carrier aggregation.

The CCs in CA may or may not be co-located in the same site or radio network node, e.g. radio base station, relay, mobile relay etc. For instance the CCs may originate, i.e. transmitted/received, at different locations, e.g., from non-located base stations, or from base stations and Remote Radio Head (RRH), or at Remote Radio Units (RRUs). The well-known examples of combined CA and multi-point communication are Distributed Antenna System (DAS), RRH, RRU, Coordinated Multi Point (CoMP), multi-point transmission/reception etc.

### SUMMARY

It is an object of embodiments herein to provide a way of improving the handling of interference in a radio communications network.

According to a first aspect of embodiments herein, the object is achieved by a method performed by a radio node of handling interference. The radio node comprises an enhanced receiver. The radio node operates in a radio communications network. The radio node obtains a bandwidth information for a determined interferer in the radio communications network. The interferer is a first signal, a first channel, a first radio node, a first antenna or a first cell, interfering on one of: a second signal, a second channel, a second radio node, a second antenna and a second cell in the radio communications network. The radio node applies the enhanced receiver to mitigate interference from the determined interferer using the obtained bandwidth information. The radio node applies the enhanced receiver to perform at least one radio measurement on the one of: the second signal, the second channel, the second radio node, the second antenna and the second cell.

According to a second aspect of embodiments herein, the object is achieved by a method performed by a network node of using a capability information. The network node operates in the radio communications network. The network node receives from the radio node the capability information associated with an ability of the radio node to mitigate interference from an interferer with a determined bandwidth. The interferer is the first signal, the first channel, the first radio node, the first antenna or the first cell, interfering on the one of: the second signal, the second channel, the second radio node, the second antenna and the second cell in the radio communications network, the radio node has the enhanced receiver. The radio node operates in the radio communications network. The network node performs one or more of: a configuration, a coordination, a scheduling and a decision, using the received capability information.

According to additional aspects of embodiments herein, the object is achieved by corresponding embodiments in the radio node and the network node.

By applying the enhanced receiver to mitigate interference from the determined interferer using the obtained bandwidth information of the interferer, the radio node may e.g., better mitigate the interference generated by the interferer, optimize receiver configuration, and/or improve performance.

By performing one or more of: a configuration, a coordination, a scheduling and a decision, using the received capability information from the radio node, the network node may e.g., adapt to the capability when: configuring measurements, processing measurements, generating the assistance data to facilitate receiver performance, perform interference coordination, configure cells, scheduling radio transmissions, etc. . . .

### BRIEF DESCRIPTION OF THE DRAWINGS

Embodiments will now be described in more detail in relation to the enclosed drawings, in which:

FIG. 1 is a schematic diagram illustrating various interference scenarios in heterogeneous deployments.

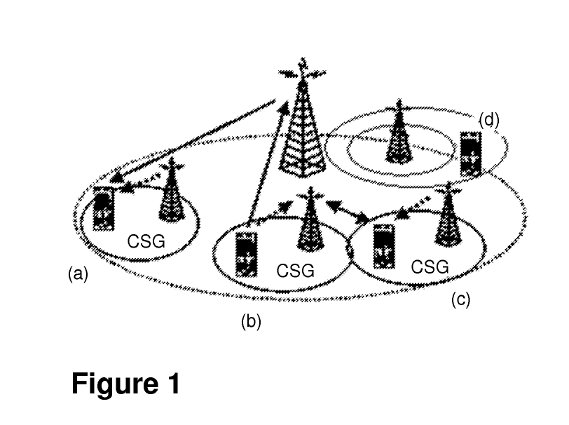

FIG. 2 is a schematic diagram illustrating cell range expansion in heterogeneous networks.

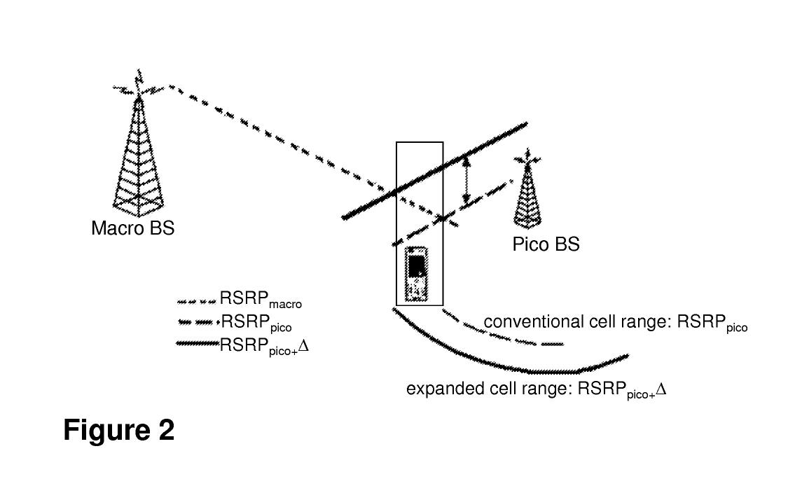

FIG. 3 is a schematic diagram illustrating PBCH transmissions in two cells with aligned radio frame boundaries.

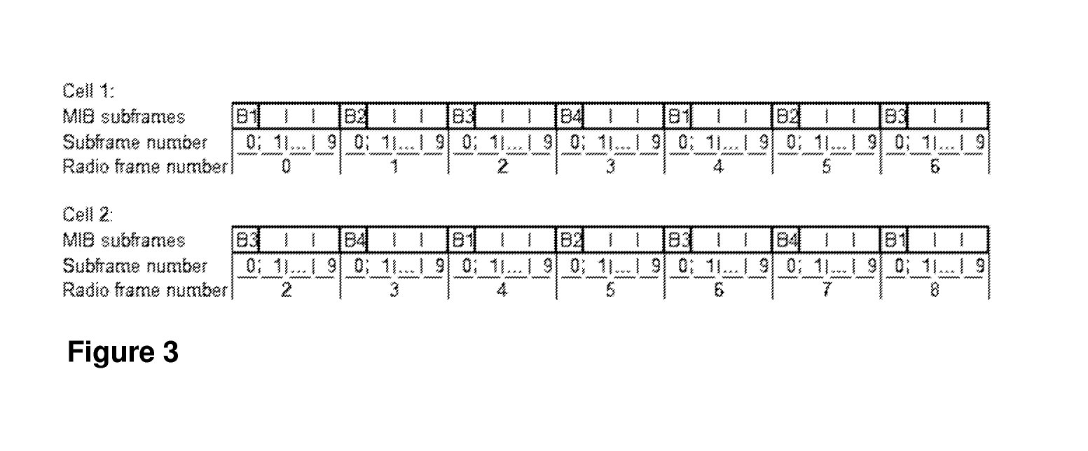

FIG. 4 is a schematic overview of embodiments in a radio communications network.

FIG. 5 is a schematic flow chart illustrating embodiments of a method in a radio node.

FIG. 6 is a schematic flow chart illustrating embodiments of a method in a network node.

FIG. 7 is a block diagram depicting embodiments of a radio node, a node controlling the radio node, or network node, and a coordinating node/network node.

### DETAILED DESCRIPTION

As part of the solution according to embodiments herein, one or more problems that may be associated with use of at least some of the prior art solutions will first be identified and discussed. At least one or more of the following problems may be solved by embodiments herein:
When an enhanced receiver is used, the interferer bandwidth is unknown to the receiver and it is assumed to be the same in the aggressor and measured cells, which may be a strong and unnecessary limitation on the network configuration. Performing measurements, only the smallest bandwidth may lead to worse performance, but may be possible e.g. for RRM measurements; however, such rule may not apply for other measurements, e.g., RLM, CSI, etc.
At least for some measurements, already with the current standard, it is possible to configure a measurement bandwidth which may be larger than the smallest channel bandwidth and smaller than the cell/system/channel bandwidth. This bandwidth, at least for non-serving aggressor cells, may be known to the enhanced receiver. When a receiver is not aware of different bandwidths of a measured signal and interfering signal, it may perform interference mitigation in an erroneous way, which may result in performance degradation; also, when the receiver is aware that the aggressor bandwidth is larger than the victim bandwidth, the performance may degrade if the interference estimation is performed over the entire aggressor bandwidth, since the generated interference may vary within the aggressor bandwidth, and not all the aggressor bandwidth will interfere on the victim bandwidth. That is, interference estimation may be too pessimistic or too optimistic.
The behavior with an enhanced receiver is currently unclear when the bandwidth of the aggressor cell and measured cell may be different. This may create ambiguity in UE implementation and issues with UE testing, resulting in that some UEs may not pass tests.

According to embodiments herein, a radio node applies an enhanced receiver to mitigate the determined aggressor interference for performing at least one radio measurement, using obtained bandwidth information.

When an enhanced receiver is used, it knows, according to embodiments herein, the interferer bandwidth, as opposed to prior art, where it is unknown and assumed to be the same in the aggressor and measured cells, which is a strong limitation on the network.

Embodiments herein may comprise at least the following example embodiments:
Methods of obtaining and using the aggressor bandwidth information
Methods related to the radio node's capability to deal with an aggressor bandwidth different or smaller than that of the victim.

Embodiments will now be described more fully hereinafter with reference to the accompanying drawings, in which examples of the claimed embodiments are shown. This claimed embodiments may, however, be embodied in many different forms and should not be construed as limited to the embodiments set forth herein. Rather, these embodiments are provided so that this disclosure will be thorough and complete, and will fully convey the scope of the claimed embodiments to those skilled in the art. It should also be noted that these embodiments are not mutually exclusive. Components from one embodiment may be tacitly assumed to be present/used in another embodiment.

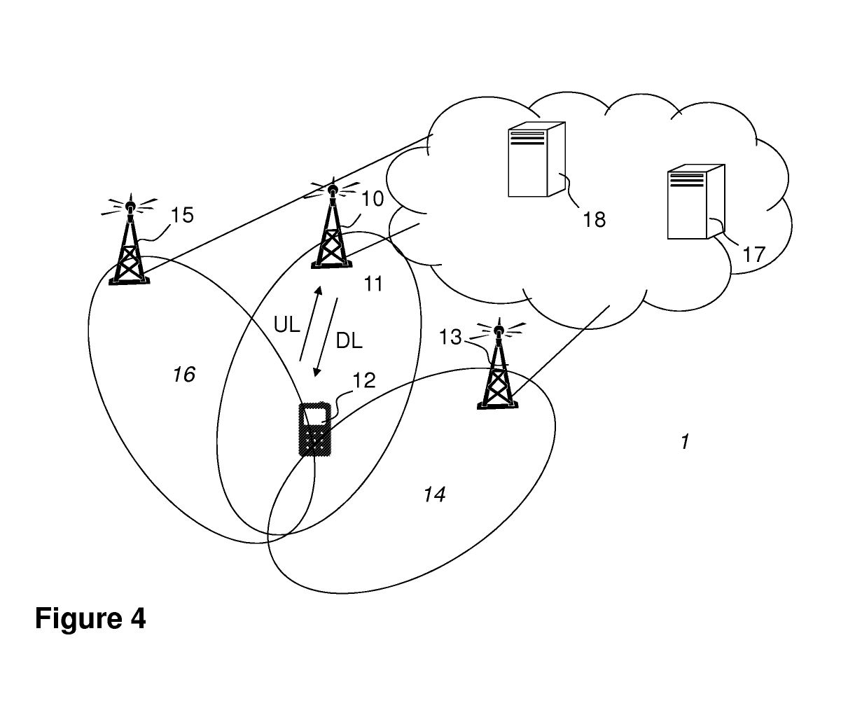

FIG. 4 is a schematic overview of a radio communications network 1, sometimes also referred to as a cellular radio system, wireless communications network or cellular network, such as a Long Term Evolution (LTE), LTE-Advanced, 3rd Generation Partnership Project (3GPP) Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), network just to mention a few possible implementations.

The radio communications network 1 comprises a radio network node 10, such as a radio node 10, e.g. a first radio base station 10, sometimes also referred to as another node. Radio network node 10 may be, for example, a base station such as e.g. an eNB, eNodeB, or a Home Node B, a Home eNode B, femto Base Station, BS, pico BS or any other network unit capable to serve a device or a machine type communication device in a radio communications network 1. In some particular embodiments, the radio network node 10 may be a stationary relay node or a mobile relay node. The radio communications network 1 covers a geographical area which is divided into cell areas, wherein each cell area is served by a network node, although, one network node may serve one or several cells. In the example depicted in FIG. 4, radio network node 10 provides radio coverage over at least one geographical area forming a first cell 11. The radio network node 10 may be of different classes, such as e.g. macro eNodeB, home eNodeB or pico base station, based on transmission power and thereby also cell size. The radio network node 10 may support one or several communication technologies, and its name may depend on the technology and terminology used.

A number of wireless devices are located in the radio communications network 1. In the example scenario of FIG. 4, only one wireless device is shown. A radio node 12 such as a wireless device 12, also referred to as a user equipment 12. The radio node 12 is a wireless communication device such as a UE which is also known as e.g. mobile terminal, wireless terminal and/or mobile station. The radio node 12 is wireless, i.e., it is enabled to communicate wirelessly in a radio communications network 1. The communication may be performed e.g., between two devices, between a device and a regular telephone and/or between a device and a server. The communication may be performed e.g., via a RAN and possibly one or more core networks, comprised within the radio communications network 1.

The radio node 12 may further be referred to as a mobile telephone, cellular telephone, or laptop with wireless capability, just to mention some further examples. The radio node 12 in the present context may be, for example, portable, pocket-storable, hand-held, computer-comprised, or vehicle-mounted mobile devices, enabled to communicate voice and/or data, via the RAN, with another entity, such as a server, a laptop, a Personal Digital Assistant (PDA), or a tablet computer, sometimes referred to as a surf plate with wireless capability, Machine-to-Machine (M2M) devices, devices equipped with a wireless interface, such as a printer or a file storage device or any other radio network unit capable of communicating over a radio link in a cellular communications system.

The radio node 12 is served in the first cell 11 by the first radio base station 10, thus the radio node 10 may be a controlling node 10 of the radio node 12, and the radio node 12 is communicating with the first radio base station 10. The user equipment 12, such as the radio node 12 transmits data over a radio interface to the first radio base station 10 in an UpLink (UL) transmission and the first radio base station 10 transmits data to the user equipment 12 in a DownLink (DL) transmission.

The radio communications network 1 may further comprise a second radio base station 13. The second radio base station 13 provides radio coverage over another geographical area forming a second cell 14. The radio communications network 1 may further comprise a third radio base station 15. The third radio base station 15 provides radio coverage over another geographical area forming a third cell 16. Each of the second radio base station 13 and the third radio base station 15 have equivalent descriptions to that of the first radio base station 10.

Furthermore, the radio communications network 1 may comprise a network node 17, such as a positioning node, and a coordinating node 18 such as a Mobility Management Entity (MME) arranged in a core network of the radio communications network 1.

The positioning node may also be exemplified as a Location Service (LCS) server, Server Mobile Location Centre (SMLC), Secure User Plane Location (SUPL) Location Platform (SLP) or any server enabled to perform positioning of the user equipment 12.

Further detailed information of the nodes described herein is provided below.

A radio node is characterized by its ability to transmit and/or receive radio signals and it comprises at least a transmitting or receiving antenna. A radio node may be a wireless device, such as the radio node 12, or a radio network node, such as radio network node 10, see corresponding descriptions. Thus, any reference to a radio node herein, is to be understood to apply to any of the radio node 12 and the radio network node 10, as described herein, and therefore, to be collectively referred to in some instances herein as radio node 10, 12, unless otherwise noted.

A wireless device and UE, such as the radio node 12, are used interchangeably in the description. Any reference to a wireless device, or UE, herein, is to be understood to apply to radio node 12, unless otherwise noted. A UE may comprise any device equipped with a radio interface and capable of at least transmitting or receiving a radio signal from another radio node. A UE may also be capable of receiving signal and demodulate it. Note that even some radio network nodes, e.g., femto BS, aka home BS, may also be equipped with a UE-like interface, although this is not depicted in the non-limiting embodiment of FIG. 4. Some example of “UE” that are to be understood in a general sense are PDA, laptop, mobile, a tablet device, sensor, fixed relay, mobile relay, any radio network node equipped with a UE-like interface, e.g., small RBS, eNodeB, femto BS.

A radio network node, such as radio network node 10, is a radio node comprised in a radio communications network, such as radio communications network 1. Any reference to a radio network node herein, is to be understood to apply to radio network node 10, unless otherwise noted. A radio network node may be capable of receiving radio signals or transmitting radio signals in one or more frequencies, and may operate in single-RAT, multi-RAT or multi-standard mode, e.g., MSR. A radio network node, including eNodeB, RRH, RRU, or transmitting-only/receiving-only radio network nodes, may or may not create own cell. Some examples of radio network nodes not creating own cell are beacon devices transmitting configured radio signals or measuring nodes receiving and performing measurements on certain signals, e.g., LMUs. It may also share a cell or the used cell ID with another radio node which creates own cell, it may operate in a cell sector or may be associated with a radio network node creating own cell. More than one cell or cell sectors, commonly named in the described embodiments by a generalized term “cell” which may be understood as a cell or its logical or geographical part, may be associated with one radio network node. Further, one or more serving cells, in DL and/or UL, may be configured for a UE, e.g., in a carrier aggregation system where a UE may have one Primary Cell (PCell) and one or more Secondary Cells (SCells). A cell may also be a virtual cell, e.g., characterized by a cell ID but not provide a full cell-like service, associated with a transmit node.

The network node 17 may be any radio network node, such as radio network node 10, see the corresponding description, or core network node. Some non-limiting examples of a network node are an eNodeB, also radio network node, RNC, positioning node, MME, PSAP, SON node, Minimization of Drive Tests (MDT) node, coordinating node, such as coordinating node 18, a gateway node, e.g., P-GW or S-GW or LMU gateway or femto gateway, and O&M node. Thus, any reference to a network node herein, is understood to apply to any of the radio network node 10, the network node 17 and the coordinating node 18, as described herein, and therefore, to be collectively referred to in some instances herein as network node 10, 17, 18, unless otherwise noted.

The term “coordinating node”, such as coordinating node 18, used herein is a network and/or node, which coordinates radio resources with one or more radio nodes. Any reference to a coordinating node herein, is understood to apply to coordinating node 18, unless otherwise noted. Some examples of the coordinating node 18 are network monitoring and configuration node, a network node 17, OSS node, O&M, MDT node, SON node, positioning node, MME, a gateway node such as Packet Data Network Gateway (P-GW) or Serving Gateway (S-GW) network node or femto gateway node, a macro node coordinating smaller radio nodes associated with it, eNodeB coordinating resources with other eNodeBs, etc.

The signaling described in embodiments herein is either via direct links or logical links, e.g. via higher layer protocols and/or via one or more network and/or radio nodes. For example, signaling from a coordinating node to a UE may also pass another network node, e.g., a radio network node.

The described embodiments are not limited to LTE, but may apply with any Radio Access Network (RAN), single- or multi-RAT. Some other RAT examples are LTE-Advanced, UMTS, HSPA, GSM, cdma2000, WiMAX, and WiFi.

Embodiments herein also apply to multi-point transmission and/or reception systems, carrier aggregation systems, and multi-point carrier aggregation systems. The term “subframe” used in the embodiments described herein, typically related to LTE, is an example resource in the time domain, and in general it may be any pre-defined time instance or time period.

Enhanced receiver is a receiver implementing any of the embodiments described herein or implementing a receiver interference handling technique, e.g., interference cancellation, interference suppression, interference rejection, etc. . . . In some embodiments, “receiver type” may be used interchangeably with “receiver technique”.

The term “victim” may apply e.g. to a measured signal or a measured cell depending on the context, the measurements of which are performed in high-interference conditions.

The term “aggressor” may apply e.g. to a strongly interfering signal/channel or a strongly interfering radio node, e.g., a wireless device or a radio network node, or antenna or a cell, depending on the context, which interferers to the victim signal/channel/node/antenna/cell. Any reference to an aggressor herein, is understood to apply to a first signal, a first channel, a first radio node, such as the third radio base station 15, a first antenna or a first cell, such as the third cell 16, unless otherwise noted. Any reference to a victim herein, is understood to apply to a second signal, a second channel, a second radio node, such as the second radio base station 13, a second antenna or a second cell, such as the second cell 14, unless otherwise noted. In a cellular network, such as the radio communications network 1, the interference may be e.g. intra-cell or inter-cell but may also be from device-to-device communication. The aggressor signal may be transmitted by the same node or a different node than that transmitting the victim signal, e.g., a cell of the same eNodeB or a cell of a different eNodeB; an intra-cell interfering signal is transmitted in the same cell by a different UE or by the same eNodeB using a different signal characteristic.

Some examples of victim-aggressor relations: an LTE physical signal to an LTE physical signal, of the same or different type, or to an LTE physical channel, an LTE physical channel to an LTE physical channel, of the same or different type, or an LTE physical signal, a macro cell or its UE interfering to a pico cell or the pico UE, a femto cell or a CSG UE interfering to a non-CSG cell or non-SCG UE, etc.

Herein, interference handling/mitigating technique may comprise, e.g., any one or a combination of:
Interference Cancellation (IC), e.g.,
   applied on a physical signal or channel, more specifically, e.g., on PSS, SSS, CRS, PRS, PBCH, PDCCH, or enhanced PDCCH (ePDCCH), etc.;
   applied on an antenna or an antenna branch, e.g., cross polarization interference cancellation
Interference Suppression (IS)
Interference Rejection (IR)
Selective interference filtering
Puncturing or using soft weights, e.g., removing or weighting the interference on certain time and/or frequency resources such as subcarriers, resource elements, time-domain symbols, etc.

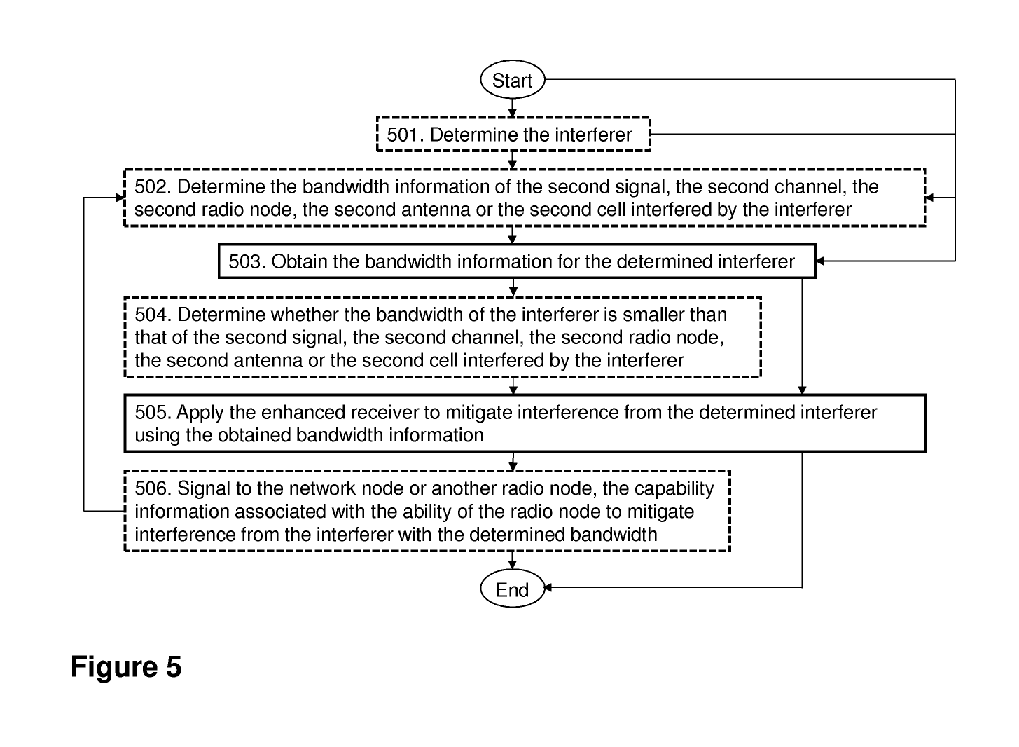

Example of embodiments of a method performed by the radio node 12 of handling interference, will now be described with reference to a flowchart depicted in FIG. 5. The radio node 12 comprises an enhanced receiver, as described earlier. The radio node 12 operates in the radio communications network 1. The method comprises the following actions, which actions may be taken in any suitable order. Dashed lines of some boxes in FIG. 5 indicate that the action is not mandatory, whereas continuous lines indicate that the actions are mandatory.

The method may comprise the following actions, which actions may as well be carried out in another suitable order than that described below. In some embodiments, all the actions may be carried out, whereas in other embodiments only some action/s may be carried out.

Action 501

In this action, the radio node 12 may determine the interferer. As stated earlier, the interferer is a first signal, a first channel, a first radio node 15, a first antenna or a first cell 16, interfering on one of: a second signal, a second channel, a second radio node 13, a second antenna and a second cell 14 in the radio communications network 1.

This action is described below in further detail, for example, under the subheading “2.1.1 Step 1: Determining the aggressor interferer/s”. Thus, any reference herein to “Step 1” may be understood to apply to Action 501, unless otherwise noted.

This action is optional.

Action 502

In this action, the radio node 12 may determine a bandwidth information of the one of: the second signal, the second channel, the second radio node, the second antenna and the second cell 14 interfered by the interferer.

This action is described below in further detail, for example, under the subheading “2.1 Embodiment herein 1: Methods in a radio node 10,12 of obtaining and using the bandwidth information for enhanced receiver”.

This action is optional.

Action 503

In this action, the radio node 12 obtains the bandwidth information for the determined interferer in the radio communications network 1.

In some embodiments, obtaining comprises reading a system information of the interferer.

In some embodiments, obtaining comprises comprises applying a pre-defined rule.

In some embodiments, a bandwidth of the interferer is at least as large as the bandwidth of the one of: the second signal, the second channel, the second radio node, the second antenna and the second cell 14.

In some embodiments, obtaining comprises receiving the bandwidth information from the network node 10, 17, 18 or another radio node. As described earlier, the network node 10, 17, 18 and the another radio node operate in the radio communications network 1.

This action is described below in further detail, for example, under the subheading “2.1.2 Step 2: Obtaining the bandwidth information for the determined aggressor interferer”. Thus, any reference herein to “Step 2” may be understood to apply to Action 503, unless otherwise noted.

Action 504

In this action, the radio node 12 may determine whether the bandwidth of the interferer is smaller than that of the one of: the second signal, the second channel, the second radio node, the second antenna and the second cell 14 interfered by the interferer

This action is described below in further detail, for example, under the subheading “2.1 Embodiment herein 1: Methods in a radio node 10,12 of obtaining and using the bandwidth information for enhanced receiver”.

This action is optional.

Action 505

In this action, the radio node 12 applies the enhanced receiver to mitigate interference from the determined interferer using the obtained bandwidth information, to perform at least one radio measurement on the one of: the second signal, the second channel, the second radio node, the second antenna and the second cell 14.

In some embodiments, the at least one radio measurement is any one of: a Radio Resource Management, RRM, measurement, a Radio Link Monitoring, RLM, measurement, and a Channel State Information, CSI, measurement.

In some embodiments, the applying may be performed for meeting a pre-defined requirement in a presence of interference from the interferer, wherein the interferer has a different bandwidth from that of the one of: the second signal, the second channel, the second radio node, the second antenna and the second cell 14.

In some embodiments, applying comprises determining resources that are affected by the interferer using the obtained bandwidth information to determine a hypothetical error. The hypothetical error may, for example, depend on a quality estimate of a received channel, the reception of which depends on the receiver ability to correctly mitigate the interference.

In some particular embodiments, the resources may be time-frequency resources.

This action is described below in further detail, for example, under the subheading “2.1.3 Step 3: Applying enhanced receiver using the bandwidth information for mitigating the interference”. Thus, any reference herein to “Step 3” may be understood to apply to Action 505, unless otherwise noted.

Action 506

In this action, the radio node 12 may signal to the network node 10, 17, 18 or another radio node, a capability information associated with an ability of the radio node 12 to mitigate interference from the interferer with a determined bandwidth. As stated earlier, the network node 10, 17, 18 operates in the radio communications network 1.

This action is described below in further detail, for example, under the subheading “2.3 Embodiment herein 3: Receiver capability associated with the aggressor interferer bandwidth”.

This action is optional.

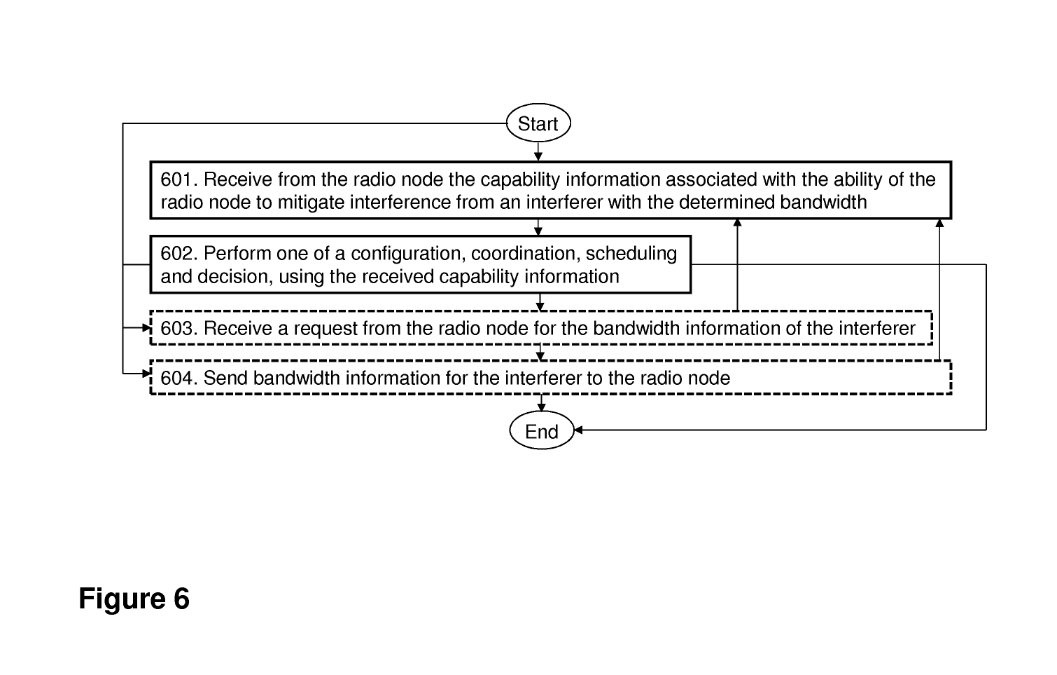

Example of embodiments of a network node 10, 17, 18 of using a capability information, will now be described with reference to a flowchart depicted in FIG. 6. The network node 10, 17, 18 operates in the radio communications network 1. The method comprises the following actions, which actions may be taken in any suitable order. Dashed lines of some boxes in FIG. 6 indicate that the action is not mandatory, whereas continuous lines indicate that the actions are mandatory.

The method may comprise the following actions, which actions may as well be carried out in another suitable order than that described below. In some embodiments, all the actions may be carried out, whereas in other embodiments only some action/s may be carried out.

Action 601

In this action, the network node 10, 17, 18 receives from the radio node 12 the capability information associated with the ability of the radio node 12 to mitigate interference from the interferer with the determined bandwidth. As described earlier, the interferer is the first signal, the first channel, the first radio node 15, the first antenna or the first cell 16, interfering on the one of: the second signal, the second channel, the second radio node 13, the second antenna and the second cell 14 in the radio communications network 1. The radio node 12 has an enhanced receiver. As stated above, the radio node 12 operates in the radio communications network 1.

This action is described below in further detail, for example, under the subheading “2.3 Embodiment herein 3: Receiver capability associated with the aggressor interferer bandwidth”.

Action 602

In this action, the network node 10, 17, 18 performs one or more of: a configuration, a coordination, a scheduling and a decision, using the received capability information.

In some embodiments, the determined bandwidth of the interferer is different from that of the one of: the second signal, the second channel, the second radio node, the second antenna and the second cell 14.

In some embodiments, the network node 10 is a serving node of the radio node 12, and the performing comprises at least one of: configuring measurements, providing assistance data to the radio node 12, performing scheduling, making handover decisions, and performing interference coordination, to enable the radio node to meet certain pre-defined requirements.

In some embodiments, the configuration comprises one of: a measurement configuration for the radio node 12 with the enhanced receiver, an assistance data configuration based on the radio node 12 capability and/or a bandwidth information of the interferer, configuring handover-related parameters, configuring cell selection or carrier selection decision related parameters and configuring measurements for a specific purpose; wherein the coordination comprises one of: an interference coordination to control interference conditions for the enhanced receiver and coordinating with neighbor nodes the bandwidth of potential victim and aggressor bandwidths; wherein the scheduling comprises one of: scheduling of transmissions for the enhanced receiver, and scheduling of transmissions that may potentially become aggressor interferers to the enhanced receiver; and wherein the decision comprises one of: a handover decision, and a cell selection or carrier selection decision.

This action is described below in further detail, for example, under the subheading “2.3 Embodiment herein 3: Receiver capability associated with the aggressor interferer bandwidth”.

Action 603

In this action, the network node 10, 17, 18 may receive a request from the radio node 12 for the bandwidth information of the interferer.

This action is described below in further detail, for example, under the subheading “2.1.2 Step 2: Obtaining the bandwidth information for the determined aggressor interferer”.

This action is optional.

Action 604

In this action, the network node 10, 17, 18 may send the bandwidth information for the interferer to the radio node 12.

This action is described below in further detail, for example, under the subheading “2.1.2 Step 2: Obtaining the bandwidth information for the determined aggressor interferer”.

This action is optional.

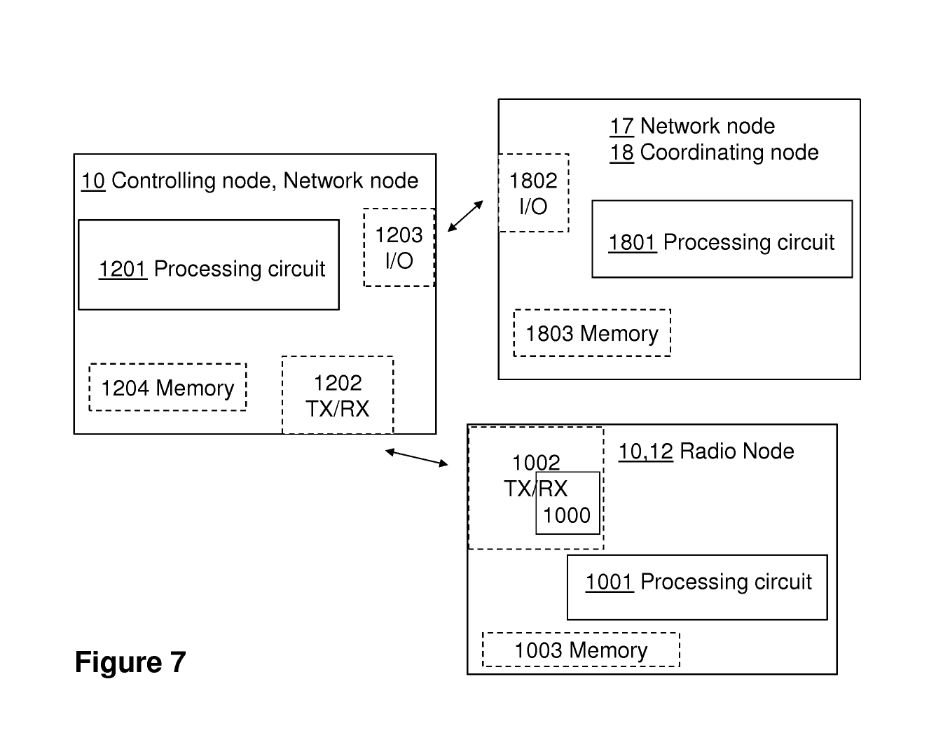

To perform the method actions in the radio node 12 described above in relation to FIG. 5 for handling interference, the radio node 12 comprises the following arrangement depicted in FIG. 7. FIG. 7 is a block diagram depicting example embodiments of the radio node 10,12, the controlling node 10 and the coordinating node 18. As stated earlier, the radio node 12 comprises the enhanced receiver, such as e.g., an enhanced receiver 1000. Also as stated earlier, the radio node 12 is configured to operate in the radio communications network 1.

The detailed description of some of the following corresponds to the same references provided above, in relation to the actions described for the radio node 12, and will thus not be repeated here. For example, further detail on how to determine the interferer is configured to be performed, may be found, for example, under the subheading “2.1.1 Step 1: Determining the aggressor interferer/s”.

The radio node 12 comprises a processing circuit 1001 configured to obtain the bandwidth information for the determined interferer in the radio communications network 1. As stated earlier, the interferer is the first signal, the first channel, the first radio node 15, the first antenna or the first cell 16, interfering on the one of: the second signal, the second channel, the second radio node 13, the second antenna and the second cell 14 in the radio communications network 1.

The processing circuit 1001 is further configured to apply the enhanced receiver 1000 to mitigate interference from the determined interferer using the obtained bandwidth information, to perform at least one radio measurement on the one of: the second signal, the second channel, the second radio node, the second antenna and the second cell 14.

In some embodiments, the at least one radio measurement may be any one of: a Radio Resource Management, RRM, measurement, a Radio Link Monitoring, RLM, measurement, and a Channel State Information, CSI, measurement.

In some embodiments, to obtain may comprise to read a system information of the interferer.

In some embodiments, the processing circuit 1001 may be further configured to determine the interferer.

In some embodiments, the processing circuit 1001 may be further configured to determine a bandwidth information of the one of: the second signal, the second channel, the second radio node, the second antenna and the second cell 14 interfered by the interferer.

In some embodiments, the processing circuit 1001 may be further configured to determine whether the bandwidth of the interferer is smaller than that of the one of: the second signal, the second channel, the second radio node, the second antenna and the second cell 14 interfered by the interferer.

In some embodiments, to obtain comprises to apply a pre-defined rule.

In some embodiments, a bandwidth of the interferer is at least as large as the bandwidth of the one of: the second signal, the second channel, the second radio node, the second antenna and the second cell 14.

In some embodiments, the processing circuit 1001 may be further configured to signal to a network node 10, 17, 18 or another radio node, a capability information associated with an ability of the radio node 12 to mitigate interference from the interferer with a determined bandwidth, the network node 10, 17, 18 being configured to operate in the radio communications network 1.

In some embodiments, to apply may be configured to be performed for meeting a pre-defined requirement in a presence of interference from the interferer, wherein the interferer has a different bandwidth from that of the one of: the second signal, the second channel, the second radio node, the second antenna and the second cell 14.

In some embodiments, to apply comprises to determine resources that are affected by the interferer using the obtained bandwidth information to determine a hypothetical error. In some particular embodiments, the resources may be time-frequency resources.

In some embodiments, to obtain comprises to receive the bandwidth information from a network node 10, 17, 18 or another radio node, the network node 10, 17, 18 and the another radio node being configured to operate in the radio communications network 1.

Embodiments herein also apply to the multi-point carrier aggregation systems but also multi-point systems without CA. The multi-carrier operation may also be used in conjunction with multi-antenna transmission. For example signals on each CC may be transmitted by the eNodeB to the UE over two or more antennas.

The embodiments described herein apply to non-CA scenarios, CA scenarios, and also scenarios with CA for specific deployments e.g. such as CoMP.

The embodiments described herein may be implemented through one or more processors, such as the processing circuit 1001 in the radio node 12, depicted in FIG. 7, together with computer program code for performing the functions and/or method steps of the embodiments herein. The program code mentioned above may also be provided as a computer program product, for instance in the form of a data carrier carrying computer program code for performing embodiments herein when being loaded into the radio node 12. One such carrier may be in the form of a CD ROM disc. It is however feasible with other data carriers such as a memory stick. The computer program code may furthermore be provided as pure program code on a server and downloaded to the radio node 12.

In some embodiments, information may be received or information may be sent or signaled through a communication interface such as a transmitter/receiver 1002 in the radio node 10,12. In some embodiments, the transmitter/receiver 1002 may be, for example, connected to the one or more antennas in the radio node 12. In other embodiments, the radio node 12 may receive information from another structure in the radio communications network 1 through the transmitter/receiver 1002. Since the transmitter/receiver 1002 may be in communication with the processing circuit 1001, the transmitter/receiver 1002 may then send the received information to the processing circuit 1001. The transmitter/receiver 1002 may also be configured to receive other information. The receiver 1002 in the radio node 10,12 may comprise an enhanced receiver, such as, e.g., the enhanced receiver 1000. The enhanced receiver 1000 may be used to implement the pertinent actions described above in reference to FIG. 5, e.g., Action 505, and FIG. 6, e.g., Action 602. The information received/sent/signaled by the processing circuit 1001 in relation to methods herein, may be stored in the memory 1003 which, as stated earlier, may be in communication with the processing circuit 1001 and the transmitter/receiver 1002.

The radio node 12 may further comprise a memory 1003 comprising one or more memory units. The memory 1003 may be arranged to be used to store data such as, the information received by the processing circuit 1001 in relation to applications to perform the methods herein when being executed in the radio node 12. Memory 1003 may be in communication with the processing circuit 1001. Any of the other information processed by the processing circuit 1001 may also be stored in the memory 1003.

Those skilled in the art will also appreciate that the various “circuits” described may refer to a combination of analog and digital circuits, and/or one or more processors configured with software and/or firmware (e.g., stored in memory) that, when executed by the one or more processors, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

Thus, the methods according to the embodiments described herein for the radio node 12 are respectively implemented by means of a computer program product, comprising instructions, i.e., software code portions, which, when executed on at least one processor, cause the at least one processor to carry out the actions described herein, as performed by the radio node 12. The computer program product may be stored on a computer-readable storage medium. The computer-readable storage medium, having stored thereon the computer program, may comprise instructions which, when executed on at least one processor, cause the at least one processor to carry out the actions described herein, as performed by the radio node 12. In some embodiments, the computer-readable storage medium may be a non-transitory computer-readable storage medium.

To perform the method actions in the network node 10, 17, 18 described above in relation to FIG. 6 for using a capability information, the network node 10, 17, 18 comprises the following arrangement depicted in FIG. 7. As stated earlier, the network node 10, 17, 18 is configured to operate in the radio communications network 1.

The detailed description of some of the following corresponds to the same references provided above, in relation to the actions described for the network node 10, 17, 18, and will thus not be repeated here. For example, further detail on how to perform one or more of: a configuration, a coordination, a scheduling and a decision, using the received capability information is configured to be performed, may be found, for example, under the subheading “2.3 Embodiment herein 3: Receiver capability associated with the aggressor interferer bandwidth”.

The network node 10, 17, 18 comprises a processing circuit 1001, 1201—in network node 10—, 1801—in network node 17,18—configured to receive from a radio node 12 the capability information associated with an ability of the radio node 12 to mitigate interference from an interferer with a determined bandwidth. As stated earlier, the interferer is the first signal, the first channel, the first radio node 15, the first antenna or the first cell 16, interfering on the one of: the second signal, the second channel, the second radio node 13, the second antenna and the second cell 14 in the radio communications network 1. The radio node 12 has the enhanced receiver 1000 and the radio node 12 is configured to operate in the radio communications network 1.

The processing circuit 1001, 1201, 1801 is further configured to perform one or more of: a configuration, a coordination, a scheduling and a decision, using the received capability information.

In some embodiments, the determined bandwidth of the interferer is different from that of the one of: the second signal, the second channel, the second radio node, the second antenna and the second cell 14.

In some embodiments, the network node 10 is a serving node of the radio node 12, and to perform comprises at least one of: to configure measurements, to provide assistance data to the radio node 12, to perform scheduling, to make handover decisions, and to perform interference coordination, to enable the radio node to meet certain pre-defined requirements.

In some embodiments, processing circuit 1001, 1201, 1801 is further configured to: send a bandwidth information for the interferer to the radio node 12.

In some embodiments, the processing circuit 1001, 1201, 1801 is further configured to receive a request from the radio node 12 for the bandwidth information of the interferer.

In some embodiments, the configuration comprises one of: a measurement configuration for the radio node 12 with the enhanced receiver 1000, an assistance data configuration based on the radio node 12 capability and/or a bandwidth information of the interferer, configuring handover-related parameters, configuring cell selection or carrier selection decision related parameters and configuring measurements for a specific purpose; wherein the coordination comprises one of: an interference coordination to control interference conditions for the enhanced receiver 1000 and coordinating with neighbor nodes the bandwidth of potential victim and aggressor bandwidths; wherein the scheduling comprises one of: scheduling of transmissions for the enhanced receiver 1000, and scheduling of transmissions that may potentially become aggressor interferers to the enhanced receiver 1000; and wherein the decision comprises one of: a handover decision, and a cell selection or carrier selection decision.

The embodiments described herein may be implemented through one or more processors, such as the processing circuit 1001, 1201, 1801 in the corresponding network node 10, 17, 18, as depicted in FIG. 7, together with computer program code for performing the functions and/or method steps of the embodiments herein. The program code mentioned above may also be provided as a computer program product, for instance in the form of a data carrier carrying computer program code for performing embodiments herein when being loaded into the network node 10, 17, 18. One such carrier may be in the form of a CD ROM disc. It is however feasible with other data carriers such as a memory stick. The computer program code may furthermore be provided as pure program code on a server and downloaded to the network node 10, 17, 18.

In some embodiments, information may be received or information may be sent or signaled through a communication interface such as a transmitter/receiver 1002 in the radio node 10, a a transmitter/receiver 1202 in the network node 10, or an Input/out (I/O) 1203, 1802 in the network node 10 and coordinating node 18, network node 17, respectively. In some embodiments, the transmitter/receiver 1002, or the I/O 1802 may be, for example, connected to the one or more antennas in the corresponding network node 10, 17, 18. In other embodiments, the network node 10, 17, 18 may receive information from another structure in the radio communications network 1 through the transmitter/receiver 1002 or the I/O 1802. Since the transmitter/receiver 1002 and the I/O 1802 may be in communication with the corresponding processing circuit 1001, 1201, 1801, the transmitter/receiver 1002, or the I/O 1802 may then send the received information to the corresponding processing circuit 1001, 1201, 1801. The transmitter/receiver 1002, or the I/O 1802 may also be configured to receive other information. The receiver in the radio node 10,12 may comprise the enhanced receiver 1000.

The network node 10, 17, 18 may further comprise a memory 1003, 1204—in network node 10, 1803—in network node 17, 18—comprising one or more memory units. The memory 1003, 1204, 1803 may be arranged to be used to store data such as, the information received by the corresponding processing circuit 1001, 1201, 1801 in relation to applications to perform the methods herein when being executed in the corresponding network node 10, 17, 18. Memory 1003, 1204, 1803 may be in communication with the corresponding processing circuit 1001, 1201, 1801. Any of the other information processed by the processing circuit 1001, 1201, 1801 may also be stored in the corresponding memory 1003, 1204, 1803.

The information received/sent/signaled by the processing circuit 1001, 1201, 1801 in relation to methods herein, may be stored in the corresponding memory 1003, 1204, 1803 which, as stated earlier, may be in communication with the corresponding processing circuit 1001, 1201, 1801 and the corresponding transmitter/receiver 1002, or the I/O 1203, 1802.

Those skilled in the art will also appreciate that the various “circuits” described may refer to a combination of analog and digital circuits, and/or one or more processors configured with software and/or firmware, e.g., stored in memory, that, when executed by the one or more processors, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

Thus, the methods according to the embodiments described herein for the network node 10, 17, 18 are respectively implemented by means of a computer program product, comprising instructions, i.e., software code portions, which, when executed on at least one processor, cause the at least one processor to carry out the actions described herein, as performed by the network node 10, 17, 18. The computer program product may be stored on a computer-readable storage medium. The computer-readable storage medium, having stored thereon the computer program, may comprise instructions which, when executed on at least one processor, cause the at least one processor to carry out the actions described herein, as performed by the network node 10, 17, 18. In some embodiments, the computer-readable storage medium may be a non-transitory computer-readable storage medium.

In some embodiments, the processing circuit 1001, 1201, 1801 described herein may alternatively be implemented with one or more modules, wherein the modules correspond to respective applications running on one or more processor.

### Further Detailed Description Relating to any Suitable Embodiment Described Above

### 2.1 Embodiment Herein 1

### Methods in a Radio Node 10,12 of Obtaining and Using the Bandwidth Information for the Enhanced Receiver, Such as, e.g., the Enhanced Receiver 1000, as Described, for Example, in Actions 502 and 504

According to some embodiments, a radio node, e.g., a wireless device or a radio network node such as LMU or eNodeB or femto BS—see other examples above, performs at least the following, see FIG. 5:

Step 1. Determining at least one aggressor interferer, as described, for example, in Action 501,
Step 2. Obtaining the bandwidth information for the determined aggressor interferer, as described, for example, in Action 503,
In one example, it is of a particular interest when the aggressor interferer bandwidth may be smaller than that of the victim bandwidth, i.e., Step 2 may be preceded with a “pre-Step 2” comprising determining whether the aggressor interferer may be smaller than that of the victim, e.g., the answer may be “may not” when the aggressor signal is CRS normally transmitted over the full channel bandwidth and the victim channel bandwidth is 1.4 Mega Hertz (MHz) which is the smallest LTE bandwidth. If the result is “may not”, the Step 2 may be skipped at least in part and the aggressor bandwidth may be determined by a pre-defined rule.
   Step 3. Applying the enhanced receiver, such as, e.g., the enhanced receiver 1000, to mitigate the determined aggressor interference for performing at least one radio measurement, using the obtained bandwidth information.
The measurements may be intra-frequency, inter-frequency, inter-RAT, inter-band measurements, and/or CA measurements; the measurements may comprise e.g., RRM, RLM measurements, or channel state related measurements, e.g. see Section 1.4 herein; 3GPP TS 36.214 v. 11.1.0, sections 4-5; examples in Section 2.1.3 herein.

In one embodiment, if Step 2 is not possible or fails for some reason, different implementations may be envisioned, e.g., any one or more of the below may apply:
a pre-defined receiver type, e.g., a puncturing receiver which excludes or assigns lower soft weights to the signal in the punctured Resource Elements (REs), may be selected and used for mitigating the interference from the corresponding aggressor interferer,
interference mitigation may be used if a certain condition is met, e.g., when the aggressor interferer is strong enough, e.g., if the aggressor interferer signal strength or signal quality is above a threshold, wherein the threshold may be an absolute value or a function of a victim signal strength or quality,
a pre-defined bandwidth, e.g., same as the victim bandwidth or the maximum LTE bandwidth or the minimum LTE bandwidth, is assumed for the corresponding aggressor interferer which is then used by the enhanced receiver, such as, e.g., the enhanced receiver 1000, to mitigate the interference.

The radio node may also determine victim bandwidth information, which may be performed prior Step 1 or in any of the Steps 1-3.

The steps above may be complemented by other steps too. The three steps are described in more detail below.

### 2.1.1 Step 1

### Determining the Aggressor Interferer/s as Described, for Example, in Action 501

The determining may be performed periodically, upon a request or an indication received from another node, e.g., upon receiving the assistance data, upon a triggering condition or an event.

Determining of the aggressor interferer may be, e.g., based on:
Autonomous detection, e.g., by performing radio signal detection, e.g., a femto BS or a wireless device detects aggressor cell based on synchronization signals or pilot signals transmitted by the aggressor cell, or based on radio measurements reported by other nodes,
Data received, via higher- and/or lower-layer signaling, from a broadcast, multicast, or unicast transmission, from another node, e.g.:
   a wireless device receives via its serving cell the aggressor cell information comprising at least one or more identifications, wherein the identifications determine the aggressor interferers, e.g., the identifications are Physical Cell Identities (PCIs) of the aggressor cells or of the possible aggressor cells,
   a radio network node receives the information about UL interference from another node,
   a radio node receives a list of transmitting radio nodes, e.g., CSG home eNodeBs to which it cannot reselect or have a restricted access and which therefore may be an aggressor to the radio node receiving and performing measurements on other signals
Combination of the two above.

Other methods of obtaining the aggressor information are not precluded herein.

### 2.1.2 Step 2

### Obtaining the Bandwidth Information for the Determined Aggressor Interferer as Described, for Example, in Actions 503, 603 and 604

In one embodiment, the obtaining may be triggered by the completion of Step 1 or may start within a pre-defined time after Step 1.

The obtaining may also comprise sending, prior to receiving the aggressor bandwidth information, a request or an indication for a need for the aggressor bandwidth information to another node.

The bandwidth information may be obtained for all or a subset of the aggressor interferers determined in Step 1. In one example, the subset may comprise a pre-defined number of aggressor interferers, e.g., up to 2 aggressor cells, even if 8 aggressor cells are comprised in the aggressor interferers information e.g. such as described in Section 1.2.2.3. In another example, the subset may comprise aggressor interferers that meet a certain criteria, e.g., having a characteristic, e.g., received signal strength or quality, Signal to Noise Ratio (SNR), Signal-to-Interference Ratio (SINR), (Es/lot), etc. . . . within a certain range with respect to a threshold or the corresponding characteristic of the victim. The size of the subset of the aggressor interferers may be determined, e.g., by characteristics of the enhanced receiver, such as, e.g., the enhanced receiver 1000, used interference mitigation technique, required memory, complexity, energy level, power consumption, victim bandwidth, larger bandwidth may require larger memory, hardware and DSP capability, etc.

In one embodiment, prior the obtaining the bandwidth information, the aggressor interferers may be further grouped in two or more groups. The grouping may depend, e.g., on the radio node's capacity and available memory, victim bandwidth, received signal characteristic, e.g., signal strength, signal quality, receive timing of the aggressor signal, transmission time alignment with the victim and/or with other aggressor interferers, etc. . . .

Obtaining the bandwidth information for the determined aggressor interferer, the bandwidth information to be used by the enhanced receiver, such as, e.g., the enhanced receiver 1000, may comprise, e.g., any one or more of:
Applying a pre-defined rule,
   The rule may apply to all or a subset of the determined aggressor interferers,
   According to one example, the UE may assume the minimum system bandwidth or a pre-defined bandwidth, e.g., 1.4 MHz, for the aggressor cell
      For example, the rule may apply selectively, depending on the measurement type or purpose, e.g., it may apply for mobility measurements and/or cell identification measurements
   According to another example, the UE may assume the same bandwidth of the aggressor as of the victim signal/channel/cell
      Such a rule may impose a requirement on the aggressor cell information, e.g., only the cells with the same bandwidth may be included in the aggressor cell information
   According to another example, the UE may assume the aggressor bandwidth to be at least as large, not smaller than, as that of the victim signal/channel/cell
   According to yet another example, the UE may not assume the same bandwidth of the aggressor as of the victim signal/channel/cell or the UE may not assume any pre-defined bandwidth of the aggressor
      In one example, such a rule is essentially that same as the UE needs to obtain the aggressor bandwidth information, e.g., by reading system information;
      The rule may also apply selectively, depending on the measurement type or purpose, e.g., it may apply for timing measurements and/or positioning measurements and/or RLM and/or CSI
Receiving from another node via broadcast, multicast, or unicast signaling,
Receiving from another node, e.g., serving node, via higher-layer signaling, e.g., RRC protocol,
   In one example, the determining based on data received from another node may comprise reading the bandwidth information from a message comprising the received data
Receiving from another node, e.g., aggressor node, via lower-layer signaling, e.g., via PBCH,
   In one example, the aggressor system information, e.g., MIB, may be read to obtain the bandwidth information
   In another example, the aggressor bandwidth information may be obtained and stored in the process of cancelling the aggressor PBCH interfering to the victim signal/channel, e.g., victim PBCH; wherein the interference cancellation may comprise decoding of aggressor PBCH prior cancelling its interference
      Note: decoding may be not necessary for cancelling; hence, in another embodiment herein the radio node intentionally performs PBCH decoding to acquire the bandwidth information during the PBCH interference cancellation
   In yet another example, there may be no need to cancel aggressor PBCH, e.g., when aggressor PBCH and victim PBCH are not aligned, however, the radio node may still acquire the aggressor PBCH to determine the aggressor bandwidth,
   In yet another example, the aggressor bandwidth is obtained during the process of verification of the aggressor cell, e.g., in Step 1, there may be determined fake aggressor cells that may not exist or may be too weak, a.k.a., phantom cells or when the aggressor cell information is based on higher-layer signaling, see e.g. Section 1.2.2.3, therefore successful detecting and decoding PBCH may be used as verification of aggressor cells,
Acquiring the previously obtained and stored information from memory, a storing device, or a database,
Acquiring from assistance data or neighbor cell list not associated with interference mitigation specifically but may be serving other purpose, e.g., positioning, mobility, general RRM neighbor-cell measurement configuration, etc.
Autonomous determining, e.g., by performing measurements on radio signals of the aggressor cell,
Any combination of the above.

Obtaining the bandwidth information may require some time. Hence, according to one embodiment, the time necessary to obtain the bandwidth information may be taken into account in a pre-defined requirement which the enhanced receiver, such as, e.g., the enhanced receiver 1000, has to meet, see Embodiment herein 2. In one example, the time until the measurement is reported may be extended for a certain methods of obtaining the bandwidth information, e.g., when System Information (SI) has to be read after receiving the aggressor information.

The bandwidth information for the determined aggressor interferer may comprise, e.g., any one or more of:
DL and/or UL bandwidth,
Bandwidth associated with only or with at least specific time resources, e.g., a set of subframes indicated by a pattern,
Center of the aggressor interferer bandwidth,
Channel bandwidth, carrier bandwidth, cell bandwidth, transmission bandwidth configuration, e.g., as in 3GPP TS 36.104, v11.2.0, section 5, or system bandwidth,
Transmission bandwidth of a specific, aggressor signal or channel,
Measurement bandwidth associated with an aggressor cell, e.g., allowedMeasBandwidth,
Measurement bandwidth for a specific, aggressor, signal or channel,
Configuration or pre-defined configuration index, the configuration comprising at least the bandwidth information, of a specific, aggressor, signal or channel,
Carrier aggregation bandwidth information: total, bandwidth of a Carrier Component (CC), or bandwidth combination for two or more component carriers,
Bandwidth information associated with one or more inter-frequencies or inter-bands,
Bandwidth information comprised in the system information, e.g., multicasted, e.g., MIB via PBCH, or unicasted, e.g., via SIB1 transmitted via dedicated signaling or other SIBs transmitted via PDSCH,
An indication on whether the bandwidth of the aggressor is smaller than the bandwidth of the victim,
The overlap between the victim bandwidth and the aggressor bandwidth or between the victim frequency resources comprised within the victim bandwidth and the aggressor frequency resources comprised within the aggressor bandwidth.
   The bandwidth information may additionally also comprise other information, e.g., any one or more of:
Carrier frequency with which the bandwidth information is associated to,
Set of REs comprising the set of frequency resources within the bandwidth comprised in the bandwidth information,
Time resources associated with the bandwidth, e.g., measurement pattern, transmission pattern, low-interference subframes, a set of all or a subset of DL transmissions, a set of all or a subset of UL transmissions, etc.,
Aggressor interferer characterization, e.g., aggressor cell PCI, signal type, etc.,
Signal direction characterization, e.g., DL or UL or device-to-device transmission, duplex configuration such as FDD/TDD/Half-Duplex FDD (HD-FDD)/WiFi, where DL and UL signals are transmitted in the same spectrum,
Area information, e.g., tracking area ID, local area ID, location region where the victim is measured, synchronization area, etc. . . .

Determining the aggressor interferer may further comprise determining the overlap between the victim bandwidth and the aggressor interferer bandwidth or between the victim time- and/or frequency resources and the aggressor interferer time- and/or frequency resources. This determining may be based on the knowledge about the victim and aggressor frequency resources allocation. The determining may be based e.g. on the assumption that both the victim bandwidth and the aggressor bandwidth are centered at the same frequency resource, e.g., same center subcarrier.

The obtained bandwidth information may be further stored, e.g., for a pre-defined time or until the measurement result of a victim signal/channel is reported or until it is used by the enhanced receiver, such as, e.g., the enhanced receiver 1000, to perform at least one measurement on a victim signal/channel/cell.

### 2.1.2.1 Signaling the Bandwidth Information as a Part of the Aggressor Cell Information

According to this part of embodiments herein, the bandwidth information is comprised in the aggressor information.

In one embodiment, the bandwidth information is an indication whether it is the same or different from a reference cell, e.g., from a serving cell or from a victim cell.

In another embodiment, the bandwidth information is an indication whether the aggressor has a smaller bandwidth than a reference where the reference may be a signal/channel/cell, e.g., a serving cell or a victim cell or a pre-defined signal of a serving cell.

In yet another embodiment, the bandwidth information may be aggregate information describing the bandwidth of multiple cells, e.g.,
The minimum bandwidth among the set of multiple cells,
The maximum bandwidth among the set of multiple cells,
An indication on whether all or a subset of the multiple cells use exactly the same or at least the same bandwidth as a reference cell,
An indication on whether at least one aggressor uses a smaller bandwidth than a reference cell.

For example, if the aggressor information is as described in Section 1.2.2.3, then the bandwidth information, DL and/or UL bandwidth, may be comprised in the aggressor cell information as, e.g.:

| | |
|---|---|
| NeighCellsCRS-Info-r11 ::= | CHOICE { |
| release | NULL, |
| setup | CRS-AssistanceInfoList-r11 |
| } | |

CRS-AssistanceInfoList-r11 ::= SEQUENCE (SIZE (1.. maxCellReport)) OF CRS-
AssistanceInfo
CRS-AssistanceInfo ::= SEQUENCE {

| | |
|---|---|
| physCellId-r11 | PhysCellId, |
| antennaPortsCount-r11 | ENUMERATED {an1, an2, an4, spare1}, |
| mbsfn-SubframeConfigList-r11 | MBSFN-SubframeConfigList |
| dl-Bandwidth | ENUMERATED { |
| | n6, n15, n25, n50, n75, n100}, |
| ul-Bandwidth | ENUMERATED { |
| | n6, n15, n25, n50, n75, n100}, |
| } | |

### 2.1.3 Step 3

### Applying Enhanced Receiver, Such as, e.g., the Enhanced Receiver 1000, Using the Bandwidth Information for Mitigating the Interference as Described, for Example, in Action 505

According to this part, the aggressor bandwidth information obtained in Step 2 is used by the enhanced receiver, such as, e.g., the enhanced receiver 1000, to mitigate the interference within the aggressor bandwidth while obtaining at least one measurement, see Section 1.4, or channel state information.

Selecting the enhanced receiver, such as, e.g., the enhanced receiver 1000, type and using the bandwidth information for mitigating the aggressor interference is further explained by means of non-limiting examples.
Some enhanced receivers, such as, e.g., the enhanced receiver 1000, may be more sensitive to or even require the aggressor bandwidth information to achieve a reasonable performance level, e.g.:
Puncturing receiver, less sensitive, may be possible to use with or without the bandwidth information, although the bandwidth information would still improve the performance,
Doing interference cancellation, IC receiver is more sensitive, on a bandwidth larger than where the signal is transmitted may, however, have a more significant impact on performance since the channel estimation on REs including the REs where the signal is not present would cause an error and a further error would be caused by subtracting the channel estimate from the received signal.

### 2.1.3.1 Multiple Aggressors

There may be more than one aggressor interferer in practice. Further, the information about more than one aggressor interferers may be available also from Step 1. Selecting a subset of aggressor interferers and/or grouping has been discussed in Step 2, where the bandwidth information may be obtained or attempted for obtaining for all or a subset of the aggressor interferers. Hence, after Step 2, the bandwidth information may be available for all or a subset of the aggressor interferers determined in Step 1. A further selection and/or grouping of aggressor interferers may be performed in Step 3. There may be a pre-defined number of aggressor interferers, e.g., up to four, that may be selected in Step 3 prior mitigating the interference from the selected aggressor interferers.

In one example, the selection and/or grouping may be based at least on the result of Step 2, e.g., one or more of the below apply:
Aggressor interferers for which obtaining the bandwidth information has resulted in a failure may be excluded prior mitigating the interference, one of the reasons of the failure might be that the aggressor interference is weak or there is a stronger aggressor interferer,
Aggressor interferers for which the bandwidth is below a threshold may be excluded or given a lower priority, e.g., aggressor interferers with 6 Radio Block (RB) bandwidth or even smaller may be excluded if the victim bandwidth is above a threshold,
Aggressor interferers may be grouped by bandwidth, e.g., aggressor interferers with the same or similar, e.g., within a range, may appear in the same group; the group size and the number of groups may be determined by one or more of: the radio node capacity, e.g., memory, storage and processing capacity, etc., energy level, power consumption, and the minimum required measurement time, e.g., determined by 36.133 or 36.101,
Aggressor interferers from the interference is to be mitigated may be determined based on the obtained bandwidth information and the enhanced receiver, such as, e.g., the enhanced receiver 1000, type

### 2.1.3.2 Example 1

### Using the Bandwidth Information for Radio Link Monitoring (RLM) with Enhanced Receiver, Such as, e.g., the Enhanced Receiver 1000

### 2.1.3.2.1 General RLM Procedure

The radio node may monitor the performance of a cell, e.g., of a serving cell, may be PCell or one or more SCells, by means of RLM or RLM related measurements. In the current 3GPP standard, the UE monitors the downlink link quality of the PCell based on the CRS. In principle the downlink link quality can be monitored also on other types of reference signals e.g. DeModulation Reference Signal (DMRS), Channel State Information-Reference Signal (CSI-RS), or signals transmitted on a new carrier type, e.g., more sparse in time and/or frequency compared a legacy carrier, etc.

The downlink link quality measurement for RLM purpose incorporates signal strength of cell-specific reference signal, or any other signal used for measurement, and total received interference, namely SNR. RLM measurement is therefore also regarded as a quality measurement.

In order to detect out-of-sync and in-sync the UE compares the estimated quality with the thresholds Qout and Qin respectively. The threshold Qout and Qin are defined as the level at which the downlink radio link cannot be reliably received and corresponds to 10% and 2% block error rate of a hypothetical PDCCH transmissions, respectively, taking into account the PCFICH errors, 3GPP TS 36.133, v11.2.0, section 7.6. Hypothetical PCFICH is assumed.

In non-DRX the out of sync and in sync status are assessed by the UE in every radio frame. In DRX the out of sync and in sync status are assessed by the UE once every DRX. When higher-layer signalling indicates certain subframes for restricted radio link monitoring, the radio link quality shall be monitored in the indicated subframes.
In non-DRX downlink link quality for out of sync and in sync are estimated over an evaluation periods of 200 ms and 100 ms respectively. In DRX downlink link quality for out of sync and in sync are estimated over the same evaluation period, which scale with the DRX cycle e.g. period equal to 20 DRX cycles for DRX cycle greater than 10 ms and up to 40 ms.

In addition to filtering on physical layer, i.e. evaluation period, the UE also applies higher layer filtering based on network configured parameters. This increases the reliability of radio link failure detection and thus avoids unnecessary radio link failure and consequently RRC re-establishment. The higher layer filtering for radio link failure and recovery detection would in general comprise also a set of network controlled parameters, such as

Hysteresis counters e.g. N310 and N311 out of sync and in sync counters respectively,

Timers e.g. T310 Radio Link Failure (RLF) timer.

In High-Speed Packet Access (HSPA) similar concept called out of sync and in sync detection are carried out by the UE. The higher layer filtering parameters, i.e. hysteresis counters and timers, are also used in HSPA. There is also RLF and eventually RRC re-establishment procedures specified in HSPA.

### 2.1.3.2.2 Using the Aggressor Interferer Bandwidth Information by the Enhanced Receiver, Such as, e.g., the Enhanced Receiver 1000

The radio node, e.g., UE or femto BS, may use the received DL signal measurement to estimate hypothetical PDCCH error, e.g., a hypothetical BLock Error Rate (BLER), and/or hypothetical PCFICH and then it may estimate the channel state information, i.e., downlink quality of the monitored link, based on the hypothetical BLER.

The obtained bandwidth information for the aggressor interferer/s may be used by the radio node to determine resources that are affected by the aggressor interferer/s. For example, the determined resources may comprise a subset of a plurality of resources, e.g., resource=RE, e.g., when the determined bandwidth is smaller than the channel bandwidth and/or when the aggressor interferer impact is not over the continuous set of resources within the determined bandwidth, e.g., CRS are transmitted on every third or sixth RE in frequency over the channel bandwidth but the aggressor bandwidth may be smaller than that of the victim; DMRS may be transmitted over a bandwidth smaller than the channel bandwidth and in selected REs which are not adjacent in frequency; PSS/SSS are transmitted on six center REs irrespective of the channel bandwidth.
In one embodiment, depending on the type of the enhanced receiver these determined resources may be excluded when determining the hypothetical error. For example, this may be done with a puncturing receiver or the receiver capable of interference cancellation.
In another embodiment, the determined resources may be included when determining the hypothetical error. In this, case, the determined subset of REs may be accounted differently from other REs. In one example, a different interference level may be assumed in this subset of REs, which may determine the hypothetical error, e.g., a higher aggressor interference, in total and/or per aggressor interferer, may increase the error.

In the prior art, the determining of the hypothetical error may comprise mapping of the received victim signal characteristic, e.g., signal strength or quality or SNR or Es/lot, to a hypothetical error, depending, e.g., on the victim bandwidth. The mapping may also depend on the number of control symbols which impacts the hypothetical PCFICH. Thus, according to another embodiment herein, the determining of the hypothetical error depends not only on the victim bandwidth but also on the determined aggressor interferer bandwidth of one or more aggressor interferers and/or on the relation, e.g., amount of overlap, between the victim bandwidth and aggressor interferer bandwidth.

In one example, a pessimistic hypothetical error may be determined. The pessimistic hypothetical error maybe determined, e.g.:
Based on the assumption that the aggressor bandwidth is not smaller than the victim bandwidth,
Based on the assumption that the hypothetical error is determined by the overlap of the aggressor and victim bandwidth, e.g., the minimum of the two when the bandwidths are centered at the same point in frequency, example: victim has 5 MHz or 25 RBs, aggressor has 1.4 MHz or 6 RBs, and the overlap is 1.4 MHz or 6 RBs, hence the hypothetical error is based on 1.4 MHz or 6 RBs.

In another example, the determining may comprise determining a different hypothetical error, depending on the aggressor bandwidth, e.g., use a different mapping or a different margin or a different compensation when, e.g., any one or more apply:
the bandwidth of the victim and aggressor/s are different,
the aggressor bandwidth is smaller than that of the victim,
the victim bandwidth and the aggressor bandwidth overlap in frequency.

The margin or the compensation may comprise an additional hypothetical error Δ1 which may be added or subtracted to/from a reference hypothetical error. In one example, the reference hypothetical error may be e.g. the error when the aggressor bandwidth is the same or larger than that of the victim and/or when the aggressor bandwidth is a pre-defined value and/or the bandwidth overlap is a pre-defined value. For example, a negative margin may be added, i.e., resulting in a smaller hypothetical error, when the aggressor bandwidth is smaller than that of the victim bandwidth.

The margin or the compensation may comprise an additional signal characteristic Δ2, e.g., ΔSNR, ΔRSRP, received signal strength difference Δ2, or received signal quality Δ2, etc., which may be added or subtracted to/from a reference signal characteristic. In one example, the reference signal characteristic may be e.g. the average signal characteristic when the aggressor bandwidth is the same or larger than that of the victim. The margin or the compensation Δ1 or Δ2 may further depend on the signal characteristic, e.g., signal strength and/or quality, SNR, etc., of the victim and/or aggressor.

### 2.1.3.3 Example 2

### Using the Bandwidth Information for RLM with Enhanced Receiver, Such as, e.g., the Enhanced Receiver 1000

According to this part of embodiments herein, the radio node, e.g., UE, eNodeB, or UE's serving eNodeB, may use the received DL signal measurement to determine the channel state information, wherein the channel state information is one of a channel quality indication, a Modulation and Coding Scheme (MCS), a Rank Indication (RI), or a Precoding Matrix Indication (PMI).

The embodiments describing procedures of determining the channel state information may be as described in Section 2.1.3.2.2, i.e., as for RLM, where the “hypothetical error” would have to be replaced by the “channel state information” and an increased hypothetical error would correspond to a worse channel state characteristic. Also, similar to the above, pessimistic channel state information may be determined, or a margin or a compensation factor may be determined in the process of determining the channel state information using the aggressor interferer bandwidth information.

### 2.2 Embodiment Herein 2

### Methods for Meeting Pre-Defined Requirements and Passing Tests in the Presence of Aggressor Interference with a Different Bandwidth

### 2.2.1 Compliance to Pre-Define Requirements

According to embodiments in this section,
a radio node may adapt, e.g., any one or more of: selecting receiver type, its receiver configuration, measurement configuration, measurement procedure, aggressor bandwidth information acquisition, aggressor SI reading, memory allocation, etc. to meet certain pre-defined requirements,
a node controlling/serving the radio node, e.g., serving eNodeB, may, e.g., do one or more of: configure measurements, build up and provide assistance data to the radio node, perform scheduling, make handover decisions, and perform interference coordination, to enable the radio node to meet certain pre-defined requirements,
a coordinating node may perform coordination of scheduling, interference coordination, measurement configuration, assistance data provisioning, etc., to enable the radio node to meet certain pre-defined requirements.

For the above, embodiments described in Embodiments herein 1 and 3 may be used. The measurements may be intra-frequency, inter-frequency, inter-RAT, inter-band measurements, and/or CA measurements.

For example, it may be required to report one or more measurements within a certain time and/or with a certain pre-defined measurement accuracy level. Some more specific examples of the requirements are cell identification requirements, e.g., when the UE is required within a pre-defined time to report one measurement for each of a pre-defined number of correctly detected cells, RLM out-of-sync and in-sync requirements, and CSI requirements. The requirements may apply based on a certain enhanced receiver, such as, e.g., the enhanced receiver 1000, capability, e.g., receivers capable of IC; the requirements may also apply for radio nodes with a special capability to mitigate interference from aggressor with a different bandwidth, see e.g., Embodiment herein 3, if such capability is not comprised in the enhanced receiver, such as, e.g., the enhanced receiver 1000, capability.

In yet another example, a pre-defined measurement requirement, e.g., as exemplified above, may have to be met under one or more additional conditions, e.g., any one or more of:
Time misalignment between victim and aggressor signals is within a threshold or a range e.g. ±200 ns,
The aggressor and victim signals have aligned radio frame boundaries,
Frequency error between victim and aggressor signals is within a threshold or a range,
The aggressor signal is X decibels (dB), e.g. X=9 dB, stronger than victim signal,
The UE is provided with the CRS assistance information, which is essentially the aggressor information, via higher layers, see also Section 1.2.2.3,
The CRS assistance data is valid during the entire measurement period,
A channel characteristic has an acceptable level based on a comparison to a reference value, e.g., Doppler shift or speed is below a threshold or a delay spread is below a threshold; e.g. requirements are defined for ETU30,
The number of aggressor cells does not exceed a pre-defined number, e.g., 2,
Enhanced receiver, such as, e.g., the enhanced receiver 1000, of a certain type is used or the receiver has a certain capability associated with mitigation the aggressor interference, e.g., IC,
The aggressor is not a CSG cell,
The applicable bandwidth for the requirement is defined based on a pre-defined rule, see also Steps 1&2 of Embodiment herein 1,
The applicable bandwidth is one bandwidth, e.g., minimum of victim and aggressor bandwidths;
The applicable bandwidth is a combination of the victim bandwidth at least one aggressor bandwidth, the aggressor bandwidth may be the aggressor bandwidth acquired in Step 2 by any of the described approaches.

When the aggressor bandwidth is different from the victim bandwidth and/or smaller than the victim bandwidth and/or smaller than the victim bandwidth by a pre-defined amount, the applicable pre-defined requirement may be different from what would be required if the aggressor bandwidth would be the same as the victim bandwidth. The requirement may also depend on whether the aggressor bandwidth information is available or not or the receiver needs to make an assumption, e.g., a qualified guess, on the aggressor bandwidth.

In one example, the measurement time may be extended if it includes the time necessary to acquire the aggressor bandwidth. Alternatively, the measurement time may be the same but a certain time would be allowed in a test prior the measurement starts to allow the radio node to acquire the aggressor cell bandwidth.

In another example, the pre-defined accuracy may be better and/or the associated interference conditions may be different when the receiver is aware of the aggressor bandwidth, which is different and/or smaller than that of the victim, and uses it when mitigating the interference compared to when the receiver is not aware or not uses the aggressor bandwidth information and the aggressor bandwidth is different and/or smaller than that of the victim.

### 2.2.1.1 Compliance to Tests

The methods described in embodiments herein, e.g., the method of adapting the receiver and/or measurement procedures and/or obtaining the necessary information and methods of meeting a pre-defined requirement, e.g., as described above may also be configured in the Test Equipment (TE) node, a.k.a. System Simulator (SS) or Test System (TS). The TE or SS will have to implement all configuration methods related to embodiments applicable to different nodes e.g. victim node and at least one aggressor node. A victim node may be a wireless device served by a serving radio node. An aggressor node, depending on the measured signal may be the serving radio node or another radio node.

The purpose of the test is to verify that the radio nodes, victim node, serving radio node, coordinating node, etc. are compliant to the pre-defined rules, protocols, signaling and requirements associated with obtaining and using the aggressor bandwidth information for mitigating the interference with enhanced receiver, such as, e.g., the enhanced receiver 1000.

Typically the TE or SS or TS separately performs tests for UE and radio network nodes.

The testing may be measurement-specific and may be capability-dependent. For example, requirements described in preceding section may be verified with such TE or SS.

For UE testing, the TE or SS will also be capable of:
Receiving the measurement results from a measuring node,
Analyzing the received results e.g. comparing the measurement result or the statistics of the measurement results, e.g., with 90% confidence, obtained in the test with the reference results to determine whether measuring device is compliant to the requirements or not. The reference can be based on the pre-defined requirements or UE behavior or theoretical estimate or performed by a reference device. The reference device can be part of TE or SS.

The test setup may depend on the method of obtaining the aggressor bandwidth information. For example, acquiring the aggressor bandwidth information may require some time, e.g., SI reading may require up to 150 ms and MIB reading and decoding may require up to 40-50 ms. Hence, according to one embodiment, the time necessary to obtain the bandwidth information may be taken into account. In one example, the measurement time may be extended at least by the time necessary to acquire the bandwidth information or the assistance data may be provided at least ΔT ms before the measurement time counting starts to allow enough time for the radio node to acquire the bandwidth information. The additional time ΔT ms may be shorter if the aggressor bandwidth information is provided by higher-layer signaling, processing of high-layer signaling messages typically does not take longer than 15-30 ms.

The additional time ΔT may be different if the aggressor is a CSG cell, since the UE may create autonomous gaps for SI reading of CSG which may increase the measurement time.

### 2.3 Embodiment Herein 3

### Receiver Capability Associated with the Aggressor Interferer Bandwidth, as Described, for Example, in Actions 506, 601 and 602

Not all enhanced receiver, such as, e.g., the enhanced receiver 1000, types and not all radio nodes may be capable of mitigating the aggressor interference when the aggressor bandwidth is different from that of the victim.

Hence, according to a basic embodiment of this part of embodiments herein, a radio node maintains capability information associated with its ability to mitigate the interference from the aggressor interferer, e.g., signal, channel, or cell, with a bandwidth different from that of the victim, e.g., signal, channel, or bandwidth. In another embodiment, a radio node maintains capability information associated with its ability to mitigate the interference from the aggressor interferer, e.g., signal, channel, or cell, with a bandwidth smaller than that of the victim, e.g., signal, channel, or bandwidth.

In one example, such capability may determine the enhanced receiver, such as, e.g., the enhanced receiver 1000, sub-type, e.g., IC receiver with the ability to deal with the aggressor interference bandwidth smaller than the victim bandwidth.

In yet another embodiment, the capability information may be, e.g.:
Pre-determined and/or comprised in another, more general capability, e.g., all Rel-12 LTE UEs have such capability and some Rel-11 LTE UE has IC capability but not capable with dealing with a different aggressor bandwidth
Signaled to another node, directly or via another node, e.g.:
UE->eNodeB; UE->UE; UE->eNodeB1->eNodeB2; UE->network node, e.g., positioning node,
eNodeB->eNodeB; eNodeB->UE

This capability information, of one or more radio nodes, may be used by the node obtaining the capability, e.g., for:
Measurement configuration for the radio node with the enhanced receiver, such as, e.g., the enhanced receiver 1000
Assistance data configuration, e.g., including in the aggressor cell list cells with the bandwidth for which the UE may mitigate the interference, based on the respective UE capability and/or the aggressor bandwidth information
Interference coordination to control interference conditions for the enhanced receiver, such as, e.g., the enhanced receiver 1000
Scheduling of the transmissions for the enhanced receiver, such as, e.g., the enhanced receiver 1000, e.g., BandWidth (BW) configuration or selecting time- and/or frequency resources,
Scheduling of the transmissions that may potentially become aggressor interferers to the enhanced receiver, such as, e.g., the enhanced receiver 1000, e.g., BW configuration or selecting time- and/or frequency resources,
Handover decision or configuring handover-related parameters
Cell selection or carrier selection decision or configuring the related parameters
Coordinating with neighbor nodes the bandwidth of potential victim and aggressor bandwidths
Configuring measurements for specific purpose, e.g., positioning, MDT, SON, etc.

Furthermore, the capability may also determine how the enhanced receiver, such as, e.g., the enhanced receiver 1000 performs measurements itself in the presence of the aggressor interference, e.g., measurement bandwidth configuration, measurement sampling, measurement grouping, signal processing, memory allocation, signal combining, e.g., of the parts of the signal within and beyond the aggressor interferer's bandwidth, etc.

Radio nodes capable of handling the aggressor interference with a different bandwidth may also implement Embodiments herein 1 and 2. Radio nodes without such capability may apply, e.g., pessimistic bandwidth approach described above, or use a pre-defined rule for the aggressor interferer bandwidth assumption.

Some of the advantages that can be envisioned with the described embodiments are as follows:
Possibility to improve receiver performance
Possibility for more flexible enhanced receivers, such as, e.g., the enhanced receiver 1000,

Modifications and other embodiments of the disclosed embodiments will come to mind to one skilled in the art having the benefit of the teachings presented in the foregoing descriptions and the associated drawings. Therefore, it is to be understood that the embodiment/s is/are not to be limited to the specific embodiments disclosed and that modifications and other embodiments are intended to be included within the scope of this disclosure. Although specific terms may be employed herein, they are used in a generic and descriptive sense only and not for purposes of limitation.

### ABBREVIATIONS

3GPP 3^{rd} Generation Partnership Project
BS Base Station
CRS Cell-specific Reference Signal
eNodeB evolved Node B
E-SMLC Evolved SMLC
LTE Long-Term Evolution
LMU Location Measurement Unit
MDT Minimization of Drive Tests
MME Mobility Management Entity
PCI Physical Cell Identity
PLMN Public Land Mobile Network
PRS Positioning Reference Signals
RF Radio Frequency
RRC Radio Resource Control
RSRP Reference Signal Received Power
RSRQ Reference Signal Received Quality
RSSI Received Signal Strength Indicator
SINR Signal-to-Interference Ratio
SON Self-Optimized Network
SRS Sounding Reference Signals
UE User Equipment
UMTS Universal Mobile Telecommunications System

1. A method performed by a radio node of handling interference, the radio node comprising an enhanced receiver, and the radio node operating in a radio communications network, the method comprising:
obtaining a bandwidth information for a determined interferer in the radio communications network, the interferer being a first signal, a first channel, a first radio node, a first antenna or a first cell, interfering on one of a second signal, a second channel, a second radio node, a second antenna and a second cell in the radio communications network, and
applying the enhanced receiver to mitigate interference from the determined interferer using the obtained bandwidth information, to perform at least one radio measurement on the one of: the second signal, the second channel, the second radio node, the second antenna and the second cell.

2. The method of claim 1, wherein the at least one radio measurement is any one of a Radio Resource Management, RRM, measurement, a Radio Link Monitoring, RLM, measurement, and a Channel State Information, CSI, measurement.

3. The method of claim 1, wherein obtaining comprises reading a system information of the interferer.

4. The method of claim 1, further comprising determining the interferer.

5. The method of claim 1, further comprising determining a bandwidth information of the one of the second signal, the second channel, the second radio node, the second antenna and the second cell interfered by the interferer.

6. The method of claim 5, further comprising determining whether the bandwidth of the interferer is smaller than that of the one of the second signal, the second channel, the second radio node, the second antenna and the second cell interfered by the interferer.

7. The method of claim 1, wherein obtaining comprises applying a pre-defined rule.

8. The method of claim 5, wherein a bandwidth of the interferer is at least as large as the bandwidth of the one of: the second signal, the second channel, the second radio node, the second antenna and the second cell.

9. The method of claim 1, further comprising signalling to a network node or another radio node, a capability information associated with an ability of the radio node to mitigate interference from the interferer with a determined bandwidth, the network node operating in the radio communications network.

10. The method of claim 1, wherein the applying is performed for meeting a pre-defined requirement in a presence of interference from the interferer, wherein the interferer has a different bandwidth from that of the one of: the second signal, the second channel, the second radio node, the second antenna and the second cell.

11. The method of claim 12, wherein applying comprises determining resources that are affected by the interferer using the obtained bandwidth information to determine a hypothetical error.

12. The method of claim 1, wherein obtaining comprises receiving the bandwidth information from a network node or another radio node, the network node and the another radio node operating in the radio communications network.

13. A method performed by a network node of using a capability information, the network node operating in a radio communications network, the method comprising:
receiving from a radio node the capability information associated with an ability of the radio node to mitigate interference from an interferer with a determined bandwidth, the interferer being a first signal, a first channel, a first radio node, a first antenna or a first cell, interfering on one of: a second signal, a second channel, a second radio node, a second antenna and a second cell in the radio communications network, the radio node having an enhanced receiver and the radio node operating in the radio communications network, and
performing one or more of a configuration, a coordination, a scheduling and a decision, using the received capability information.

14. The method of claim 13, wherein the determined bandwidth of the interferer is different from that of the one of: the second signal, the second channel, the second radio node, the second antenna and the second cell.

15. The method of claim 13, wherein the network node is a serving node of the radio node, and wherein the performing comprises at least one of: configuring measurements, providing assistance data to the radio node, performing scheduling, making handover decisions, and performing interference coordination, to enable the radio node to meet certain pre-defined requirements.

16. The method of claim 13 further comprising: sending a bandwidth information for the interferer to the radio node.

17. The method of claim 16, further comprising receiving a request from the radio node for the bandwidth information of the interferer.

18. The method of claim 13, wherein the configuration comprises one of: a measurement configuration for the radio node with the enhanced receiver, an assistance data configuration based on the radio node capability and/or a bandwidth information of the interferer, configuring handover-related parameters, configuring cell selection or carrier selection decision related parameters and configuring measurements for a specific purpose; wherein the coordination comprises one of: an interference coordination to control interference conditions for the enhanced receiver and coordinating with neighbor nodes the bandwidth of potential victim and aggressor bandwidths; wherein the scheduling comprises one of scheduling of transmissions for the enhanced receiver, and scheduling of transmissions that may potentially become aggressor interferers to the enhanced receiver; and wherein the decision comprises one of: a handover decision, and a cell selection or carrier selection decision.

19. A radio node for handling interference, the radio node comprising an enhanced receiver, and the radio node configured to operate in a radio communications network, the radio node comprising a processing circuit configured to:
obtain a bandwidth information for a determined interferer in the radio communications network, the interferer being a first signal, a first channel, a first radio node, a first antenna or a first cell, interfering on one of: a second signal, a second channel, a second radio node, a second antenna and a second cell in the radio communications network, and
apply the enhanced receiver to mitigate interference from the determined interferer using the obtained bandwidth information, to perform at least one radio measurement on the one of: the second signal, the second channel, the second radio node, the second antenna and the second cell.

20. The radio node of claim 19, wherein the at least one radio measurement is any one of: a Radio Resource Management, RRM, measurement, a Radio Link Monitoring, RLM, measurement, and a Channel State Information, CSI, measurement.

21. The radio node of claim 19, wherein to obtain comprises to read a system information of the interferer.

22. The radio node of claim 19, wherein the processing circuit is further configured to determine the interferer.

23. The radio node of claim 19, wherein the processing circuit is further configured to determine a bandwidth information of the one of the second signal, the second channel, the second radio node, the second antenna and the second cell interfered by the interferer.

24. The radio node of claim 23, wherein the processing circuit is further configured to determine whether the bandwidth of the interferer is smaller than that of the one of: the second signal, the second channel, the second radio node, the second antenna and the second cell interfered by the interferer.

25. The radio node of claim 19, wherein to obtain comprises to apply a pre-defined rule.

26. The radio node of claim 23, wherein a bandwidth of the interferer is at least as large as the bandwidth of the one of: the second signal, the second channel, the second radio node, the second antenna and the second cell.

27. The radio node of claim 19, wherein the processing circuit is further configured to signal to a network node or another radio node, a capability information associated with an ability of the radio node to mitigate interference from the interferer with a determined bandwidth, the network node being configured to operate in the radio communications network.

28. The radio node of claim 19, wherein to apply is configured to be performed for meeting a pre-defined requirement in a presence of interference from the interferer, wherein the interferer has a different bandwidth from that of the one of: the second signal, the second channel, the second radio node, the second antenna and the second cell.

29. The radio node of claim 28, wherein to apply comprises to determine resources that are affected by the interferer using the obtained bandwidth information to determine a hypothetical error.

30. The radio node of claim 19, wherein to obtain comprises to receive the bandwidth information from a network node or another radio node, the network node and the another radio node being configured to operate in the radio communications network.

31. A network node for using a capability information, the network node being configured to operate in a radio communications network, the network node comprising a processing circuit configured to:
receive from a radio node the capability information associated with an ability of the radio node to mitigate interference from an interferer with a determined bandwidth, the interferer being a first signal, a first channel, a first radio node, a first antenna or a first cell, interfering on one of: a second signal, a second channel, a second radio node, a second antenna and a second cell in the radio communications network, the radio node having an enhanced receiver and the radio node being configured to operate in the radio communications network, and
perform one or more of: a configuration, a coordination, a scheduling and a decision, using the received capability information.

32. The network node of claim 31, wherein the determined bandwidth of the interferer is different from that of the one of: the second signal, the second channel, the second radio node, the second antenna and the second cell.

33. The network node of claim 31, wherein the network node is a serving node of the radio node, and wherein to perform comprises at least one of: to configure measurements, to provide assistance data to the radio node, to perform scheduling, to make handover decisions, and to perform interference coordination, to enable the radio node to meet certain pre-defined requirements.

34. The network node of claim 31 wherein the processing circuit is further configured to: send a bandwidth information for the interferer to the radio node.

35. The network node of claim 34, wherein the processing circuit is further configured to receive a request from the radio node for the bandwidth information of the interferer.

36. The network node of claim 31, wherein the configuration comprises one of a measurement configuration for the radio node with the enhanced receiver, an assistance data configuration based on the radio node capability and/or a bandwidth information of the interferer, configuring handover-related parameters, configuring cell selection or carrier selection decision related parameters and configuring measurements for a specific purpose; wherein the coordination comprises one of: an interference coordination to control interference conditions for the enhanced receiver and coordinating with neighbor nodes the bandwidth of potential victim and aggressor bandwidths; wherein the scheduling comprises one of: scheduling of transmissions for the enhanced receiver, and scheduling of transmissions that may potentially become aggressor interferers to the enhanced receiver; and wherein the decision comprises one of: a handover decision, and a cell selection or carrier selection decision.

37. Computer program, comprising instructions which, when executed on at least one processor, cause the at least one processor to carry out the method according to claim 1.

38. Computer program, comprising instructions which, when executed on at least one processor, cause the at least one processor to carry out the method according to claim 13.

39. A computer-readable storage medium, having stored thereon a computer program, comprising instructions which, when executed on at least one processor, cause the at least one processor to carry out the method according to claim 1.

40. A computer-readable storage medium, having stored thereon a computer program, comprising instructions which, when executed on at least one processor, cause the at least one processor to carry out the method according to claim 13.
